(19) United States
(12) Patent Application Publication
(10) Pub. No.: US 2023/0409673 A1
(43) Pub. Date: Dec. 21, 2023

(54) UNCERTAINTY SCORING FOR NEURAL NETWORKS VIA STOCHASTIC WEIGHT PERTURBATIONS

(71) Applicant: GE Precision Healthcare LLC, Wauwatosa, WI (US)

(72) Inventors: Ravishankar Hariharan, Bengaluru (IN); Rohan Keshav Patil, Bengaluru (IN); Rahul Venkataramani, Bengaluru (IN); Prasad Sudhakara Murthy, Bengaluru (IN); Deepa Anand, Bengaluru (IN); Utkarsh Agrawal, Bengaluru (IN)

(21) Appl. No.: 17/807,761

(22) Filed: Jun. 20, 2022

(51) Int. Cl. G06K 9/62; G06N 3/02

(52) U.S. Cl. CPC G06K 9/6265; G06K 9/6227; G06N 3/02

(57) ABSTRACT

Systems/techniques that facilitate improved uncertainty scoring for neural networks via stochastic weight perturbations are provided. In various embodiments, a system can access a trained neural network and/or a data candidate on which the trained neural network is to be executed. In various aspects, the system can generate an uncertainty indicator representing how confidently executable or how unconfidently executable the trained neural network is with respect to the data candidate, based on a set of perturbed instantiations of the trained neural network.

### TECHNICAL FIELD

The subject disclosure relates generally to neural networks, and more specifically to improved uncertainty scoring for neural networks via stochastic weight perturbations.

### BACKGROUND

After being trained, a neural network is deployed in the field so as to produce predictions and/or inferences for input data that lack ground-truth annotations. When the neural network produces a prediction/inference in the field, it can often be desirable to determine a level of uncertainty and/or confidence associated with that prediction/inference. Unfortunately, existing techniques for generating such uncertainty/confidence levels require rigid architectural restrictions, specialized training protocols, and/or excessive computational complexity.

Accordingly, systems and/or techniques that can address one or more of these technical problems can be desirable.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus and/or computer program products that facilitate improved uncertainty scoring for neural networks via stochastic weight perturbations are described.

According to one or more embodiments, a system is provided. The system can comprise a computer-readable memory that can store computer-executable components. The system can further comprise a processor that can be operably coupled to the computer-readable memory and that can execute the computer-executable components stored in the computer-readable memory. In various embodiments, the computer-executable components can comprise a receiver component. In various cases, the receiver component can access a trained neural network and/or a data candidate on which the trained neural network is to be executed. In various aspects, the computer-executable components can further comprise an uncertainty component. In various cases, the uncertainty component can generate an uncertainty indicator representing how confidently executable or how unconfidently executable the trained neural network is with respect to the data candidate, based on a set of perturbed instantiations of the trained neural network.

According to one or more embodiments, the above-described system can be implemented as a computer-implemented method and/or a computer program product.

### DESCRIPTION OF THE DRAWINGS

FIG. 1 illustrates a block diagram of an example, non-limiting system that facilitates improved uncertainty scoring for neural networks via stochastic weight perturbations in accordance with one or more embodiments described herein.

FIG. 2 illustrates a block diagram of an example, non-limiting system including a set of perturbed network instantiations that facilitates improved uncertainty scoring for neural networks via stochastic weight perturbations in accordance with one or more embodiments described herein.

FIG. 3 illustrates an example, non-limiting block diagram showing how a set of perturbed network instantiations can be generated in accordance with one or more embodiments described herein.

FIGS. 4-7 illustrate example, non-limiting graphs further explaining how a set of perturbed network instantiations can be generated in accordance with one or more embodiments described herein.

FIG. 8 illustrates a block diagram of an example, non-limiting system including an unperturbed prediction and/or a set of perturbed predictions that facilitates improved uncertainty scoring for neural networks via stochastic weight perturbations in accordance with one or more embodiments described herein.

FIG. 9 illustrates an example, non-limiting block diagram showing how an unperturbed prediction and/or a set of perturbed predictions can be generated in accordance with one or more embodiments described herein.

FIG. 10 illustrates a block diagram of an example, non-limiting system including an uncertainty indicator that facilitates improved uncertainty scoring for neural networks via stochastic weight perturbations in accordance with one or more embodiments described herein.

FIG. 11 illustrates an example, non-limiting block diagram showing how an uncertainty indicator can be generated in accordance with one or more embodiments described herein.

FIG. 12 illustrates a flow diagram of an example, non-limiting computer-implemented method that facilitates improved uncertainty scoring for neural networks via stochastic weight perturbations in accordance with one or more embodiments described herein.

FIGS. 13-14 illustrate example, non-limiting experimental results that demonstrate the efficacy of uncertainty scoring via perturbed instantiations of neural networks in accordance with one or more embodiments described herein.

FIG. 15 illustrates a flow diagram of an example, non-limiting computer-implemented method that facilitates improved uncertainty scoring for neural networks via stochastic weight perturbations in accordance with one or more embodiments described herein.

FIG. 16 illustrates a block diagram of an example, non-limiting operating environment in which one or more embodiments described herein can be facilitated.

FIG. 17 illustrates an example networking environment operable to execute various implementations described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

After being trained (e.g., in supervised fashion, unsupervised fashion, and/or reinforcement learning fashion), a neural network can be deployed in the field so as to produce predictions and/or inferences for input data that lack ground-truth annotations. As a non-limiting example, if the neural network is implemented in the medical/clinical context, the neural network can be configured to receive as input medical images (e.g., computed tomography (CT) scanned images, magnetic resonance imaging (MRI) scanned images, X-ray scanned images, ultrasound scanned images, positron emission tomography (PET) scanned images) associated with real-world medical patients and to produce as output diagnoses/prognoses (e.g., detection/localization of tumors, detection/localization of calcifications, detection/localization of vessel occlusions, identification of most preferred treatment techniques) based on such medical images. As another non-limiting example, if the neural network is implemented in the medical/clinical context, the neural network can be configured to receive as input medical images associated with real-world medical patients and to produce as output any suitable transformed, edited, and/or manipulated versions of such inputted medical images (e.g., denoised versions of such inputted medical images, resolution-enhanced versions of such inputted medical images). As still another non-limiting example, if the neural network is implemented in the medical/clinical context, the neural network can be configured to receive as input any suitable non-image inputs (e.g., sinograms for CT, k-space data for MRI) and to produce as output reconstructed images based on such non-image inputs. As yet another non-limiting example, if the neural network is implemented in the autonomous driving context, the neural network can be configured to receive as input a vehicular camera feed (e.g., images and/or videos recorded by one or more cameras mounted on a self-driving vehicle, where such such images/videos show roadway and/or traffic in front of the self-driving vehicle, roadway and/or traffic behind the self-driving vehicle, and/or roadway and/or traffic beside the self-driving vehicle) and to determine as output a next vehicular action (e.g., accelerating, decelerating, maintaining speed, turning right, veering right, turning left, veering left) to be performed based on such vehicular camera feed. As even another non-limiting example, if the neural network is implemented in the e-commerce context, the neural network can be configured to receive as input a transaction history of a customer and to determine as output a level of risk and/or fraud associated with the customer.

In any case, when the neural network produces a prediction/inference in the field, it can often be desirable to determine a level of uncertainty and/or confidence associated with that prediction/inference. Indeed, in some cases, such uncertainty/confidence computations can be required by regulatory entities (e.g., especially in the medical/clinical context and/or the autonomous driving context), in view of the fact that network uncertainty can be expected to increase (and/or network confidence can be expected to decrease) when the data on which the neural network is being inferenced is different in some respect from the data on which the neural network was trained (e.g., different demographics and/or feature distributions represented in the data, different acquisition protocols used to generate/capture the data).

Unfortunately, existing techniques for generating such uncertainty/confidence levels require rigid architectural restrictions, specialized training protocols, and/or excessive computational complexity. For instance, Markov Chain Monte Carlo (MCMC) dropout techniques generate uncertainty maps for a neural network by dropping out, during inference, different layers and/or different neurons of the neural network. Although MCMC dropout can accurately/precisely measure uncertainty/confidence, it is applicable only to specially structured neural networks. Specifically, in order for MCMC dropout to be applied to a given neural network, the given neural network must first be configured to have dropout layers and/or dropout neurons in the absence of which the given neural network can still function/operate. Indeed, as those having ordinary skill in the art will appreciate, if a non-dropout layer and/or a non-dropout neuron of the given neural network were dropped out, the given neural network would simply cease to function/operate. Accordingly, MCMC dropout can be implemented only on specialized network architectures (e.g., only on neural networks that are built/designed with dropout layers/neurons) and thus is not a universal and/or generalizable technique (e.g., most neural networks are not built/designed with dropout layers/neurons).

In other cases, Stochastic Weight Averaging (SWAG) techniques quantify uncertainty/confidence by iteratively calculating means and covariance matrices of internal parameters during training. Although SWAG techniques can measure with sufficient accuracy/precision the uncertainty/confidence of a particular neural network, such techniques require specialized computations to be performed during training of the particular neural network (e.g., require the means and covariance matrices of the internal parameters of the particular neural network to be iteratively tracked through each training epoch). In other words, if a neural network is trained without such specialized computations, then SWAG cannot be applied to that neural network. Thus, SWAG techniques are not universal and/or generalizable (e.g., during training of most neural networks, means and covariance matrices of internal parameter distributions are not tracked/recorded). Moreover, SWAG techniques often rely upon dubious assumptions (e.g., assuming a Gaussian distribution without theoretical justification), which further reduces the utility of SWAG techniques.

In yet other cases, Test-Time Augmentation techniques quantify uncertainty/confidence of a given neural network by augmenting input data in ways that were not represented in the data on which the given neural network was trained. That is, multiple copies of a piece of input data are created, such multiple copies are differently augmented (e.g., rotated, shifted, reflected, scaled up/down) in ways that introduce variety/variation that was not present in the data on which the given neural network was trained, the given neural network is executed on such augmented multiple copies, and the uncertainty/confidence of the given neural network is derived/inferred based on how agnostic or not agnostic the given neural network appears to be with respect to the augmentations. Although Test-Time Augmentation does not rely upon a particular type of network architecture and/or a particular type of training protocol, Test-Time Augmentation does require prior knowledge of augmentations that were already present/represented in the training dataset. Indeed, Test-Time Augmentation can involve meaningfully augmenting a piece of input data with the intention of diversifying that piece of input data from the training dataset, but what constitutes a meaningful augmentation cannot be known if the augmentations that were already included in the training dataset are unknown. Accordingly, Test-Time Augmentation techniques are not universal and/or generalizable (e.g., the end-users of most neural networks often do not know what augmentations were already implemented during training).

In even other cases, Deep Ensemble techniques quantify uncertainty/confidence by separately training multiple versions of a particular neural network, each of which beginning with a different random initialization. That is, multiple copies of a neural network can be created, the internal parameters of such multiple copies can each be differently randomly initialized, each of such multiple copies can be separately/independently trained, each of such separately/independently trained networks can be executed on a same piece of input data, and the degree of agreement and/or disagreement among such separately/independently trained networks can indicate how confidently/uncertainly the networks can analyze the piece of input data. Although Deep Ensemble techniques do not rely upon specific network architectures and/or specific training protocols, they are extremely computationally expensive. Indeed, fully training one neural network can be considered as time-consuming and/or resource-intensive. Thus, fully training, in separate and/or independent fashion, tens, dozens, or even hundreds of neural networks can be considered as extremely/excessively time-consuming and/or resource-intensive.

Accordingly, systems and/or techniques that can address one or more of these technical problems can be desirable.

Various embodiments described herein can address one or more of these technical problems. One or more embodiments described herein can include systems, computer-implemented methods, apparatus, and/or computer program products that can facilitate improved uncertainty scoring for neural networks via stochastic weight perturbations. In other words, the inventors of various embodiments described herein devised a technique for determining/quantifying a level of confidence/uncertainty (e.g., an uncertainty score) of a neural network with respect to a piece of input data that lacks a ground-truth, where such technique does not suffer from the same disadvantages as existing techniques for generating such uncertainty/confidence levels. In still other words, the present inventors devised a way of quantifying neural network confidence/uncertainty that does not involve the rigid architectural restrictions, specialized training protocols, and/or excessive computational complexity and/or memory costs that plague existing techniques. More specifically, the technique devised by the present inventors can include generating a confidence/uncertainty indicator for an already-trained neural network, where such confidence/uncertainty indicator can be computed/calculated based on stochastic perturbations applied to the internal parameters of such already-trained neural network.

In particular, various embodiments described herein can be considered as a computerized tool (e.g., any suitable combination of computer-executable hardware and/or computer-executable software) that can facilitate improved uncertainty scoring for neural networks via stochastic weight perturbations. In various aspects, such computerized tool can comprise a receiver component, a perturbation component, an inference component, an uncertainty component, and/or an execution component.

In various embodiments, there can be a data candidate. In various aspects, the data candidate can be any suitable type of electronic data having any suitable format and/or dimensionality. That is, the data candidate can be one or more scalars, one or more vectors, one or more matrices, one or more tensors, one or more character strings, and/or any suitable combination thereof. As a non-limiting example, the data candidate can be an image (e.g., a two-dimensional array of pixels and/or a three-dimensional array of voxels) that can depict any suitable objects as desired (e.g., can depict any suitable anatomical structure of a medical patient; can depict a roadway and/or associated automobile traffic; can depict a waterway and/or associated nautical traffic; can depict an airway and/or associated air traffic; can depict a room/sidewalk and/or associated foot traffic) and/or that can be captured/generated by any suitable imaging equipment (e.g., visible spectrum camera, CT scanner, MM scanner, X-ray scanner, ultrasound scanner, PET scanner). As another non-limiting example, the data candidate can be timeseries data representing any suitable measured quantity at various times (e.g., representing pressure measurements over time, representing temperature measurements over time, representing humidity measurements over time, representing displacement/deflection measurements over time, representing voltage measurements over time, representing amperage measurements over time, representing heartrate measurements over time, representing breathing rate measurements over time) that can be captured/generated by any suitable measurement equipment (e.g., pressure gauges/sensors, temperature gauges/sensors, humidity gauges/sensors, strain gauges/sensors, voltage/amperage gauges/sensors, heartrate gauges/sensors, breathing gauges/sensors). As yet another non-limiting example, the data candidate can be waveform data representing the frequency spectra of any suitable oscillatory signals.

In various embodiments, there can be a trained neural network. In various aspects, the trained neural network can exhibit any suitable deep learning architecture as desired. For example, the trained neural network can include any suitable types and/or numbers of layers (e.g., input layer, one or more hidden layers, output layer, any of which can be convolutional layers, batch normalization layers, and/or pooling layers), can include any suitable numbers of neurons in various layers (e.g., different layers can have the same and/or different numbers of neurons as each other), can include any suitable activation functions (e.g., softmax, sigmoid, hyperbolic tangent, rectified linear unit) in various neurons (e.g., different neurons can have the same and/or different activation functions as each other), and/or can include any suitable interneuron connections (e.g., forward connections, skip connections, recurrent connections).

In any case, the trained neural network can be configured to receive as input the data candidate and to produce as output a prediction/inference pertaining to the data candidate. In some instances, the prediction/inference can be a classification label corresponding to the data candidate. For example, if the data candidate is a medical image depicting an anatomical structure of a medical patient, the prediction/inference can be a classification label that indicates whether or not the anatomical structure is afflicted with a malady/symptom (e.g., is afflicted with a tumor, is afflicted with a calcification, is afflicted with an occlusion, is afflicted with a fracture), according to the belief/conclusion of the trained neural network. In other instances, the prediction/inference can be a segmentation corresponding to the data candidate. For example, if the data candidate is a medical image depicting an anatomical structure of a medical patient, the prediction/inference can be a pixel-wise and/or voxel-wise segmentation mask that indicates which particular pixels/voxels of the data candidate belong to which particular structural classes (e.g., a bone tissue class, a soft tissue class, a blood class, a calcification class, a tumor class, an occlusion class). In yet other instances, the prediction/inference can be a manipulated/edited version of the data candidate. For example, if the data candidate is a medical image depicting an anatomical structure of a medical patient, the prediction/inference can be a denoised and/or resolution-enhanced version of the data candidate. More generally, and as those having ordinary skill in the art will appreciate, the prediction/inference can exhibit any suitable format and/or dimensionality as desired (e.g., can be one or more scalars, one or more vectors, one or more matrices, one or more tensors, and/or one or more character strings).

In various aspects, the trained neural network can have undergone any suitable type and/or paradigm of training. For example, the trained neural network can have undergone supervised training based on an annotated training dataset. In such case, the internal parameters (e.g., weights, biases, convolutional kernels) of the neural network can have been randomly initialized. In various aspects, any suitable training data candidate and any suitable annotation corresponding to that training data candidate can have been selected from the annotated training dataset. As those having ordinary skill in the art will appreciate, the selected training data candidate can have the same format/dimensionality as the data candidate discussed above, and/or the selected annotation can likewise have the same format/dimensionality as the prediction/inference discussed above. In various instances, the selected training data candidate can have been fed as input to the neural network, which can have caused the neural network to produce some output. More specifically, in various cases, an input layer of the neural network can have received the selected training data candidate, the selected training data candidate can have completed a forward pass through one or more hidden layers of the neural network, and an output layer of the neural network can have computed the output based on activations provided by the one or more hidden layers of the neural network. In various instances, the output can be considered as the prediction/inference (e.g., predicted/inferred classification label, predicted/inferred segmentation mask, predicted/inferred denoised image) which the neural network believed should correspond to the selected training data candidate, whereas the selected annotation can be considered as the ground-truth result (e.g., ground-truth classification label, ground-truth segmentation mask, ground-truth denoised image) that was known to correspond to the selected training data candidate. Note that, if the neural network had so far undergone no and/or little training, then the output can have been highly inaccurate (e.g., the output can have been very different from the selected annotation). In any case, an error and/or loss (e.g., cross-entropy) can have been computed between the output and the selected annotation, and the internal parameters of the neural network can have been updated by performing backpropagation (e.g., stochastic gradient descent) driven by the computed error and/or loss. In various instances, such training procedure can have been repeated for each training data candidate in the set of annotated training data candidates, with the result being that the internal parameters (e.g., weights, biases, convolutional kernels) of the neural network can have become iteratively optimized to accurately generate predictions/inferences based on inputted data candidates. Those having ordinary skill in the art will appreciate that any suitable training batch sizes, any suitable training termination criteria, and/or any suitable error/loss functions can have been implemented during such training.

Although the above example focuses on supervised training, this is a mere non-limiting example for ease of explanation. Those having ordinary skill in the art will appreciate that, in various aspects, the trained neural network can instead have undergone unsupervised training based on an unannotated training dataset and/or reinforcement training based on iterative rewards/penalties.

In any case (e.g., no matter the structure/architecture of the trained neural network, and/or no matter the training paradigm applied to the trained neural network), the trained neural network can have internal parameters (e.g., weights, biases, and/or convolutional kernels) that can have been updated and/or optimized, during training based on any suitable loss/penalty computation, so as to accurately generate predictions/inferences based on inputted data candidates.

In various instances, it can be desired to not only execute the trained neural network on the data candidate, but it can also be desired to determine how confidently and/or how unconfidently (e.g., with how much certainty and/or uncertainty) the trained neural network can analyze the data candidate. Indeed, despite being trained, it can nevertheless be possible for the trained neural network to inaccurately/incorrectly analyze the data candidate (e.g., to produce an inaccurate/incorrect prediction/inference based on the data candidate), especially in situations where the data candidate differs in some significant respect (e.g., different feature distribution, different acquisition protocol) from the data on which the trained neural network was trained. Accordingly, it can be useful, beneficial, and/or otherwise desirable to quantify with how much confidence/uncertainty the trained neural network can be accurately executed on data candidate. The computerized tool, as described herein, can facilitate such determination/quantification.

In various embodiments, the receiver component of the computerized tool can electronically receive and/or otherwise electronically access the trained neural network and/or the data candidate. In some aspects, the receiver component can electronically retrieve the trained neural network and/or the data candidate from any suitable centralized and/or decentralized data structure (e.g., graph data structure, relational data structure, hybrid data structure), whether remote from and/or local to the receiver component. In any case, the receiver component can electronically obtain and/or access the trained neural network and/or the data candidate, such that other components of the computerized tool can electronically interact with (e.g., read, write, edit, copy, manipulate) the trained neural network and/or the data candidate.

In various embodiments, the perturbation component of the computerized tool can electronically generate a set of perturbed instantiations of the trained neural network. More specifically, the perturbation component can copy and/or replicate the trained neural network any suitable number of times, thereby yielding a set of network copies each of which can be identical to the trained neural network. That is, each of the set of network copies can have internal parameters (e.g., weight values, bias values, and/or convolutional kernel values) that are identical to those of the trained neural network. In various aspects, for any given network copy, the perturbation component can stochastically/randomly perturb the internal parameters of that given network copy, thereby yielding a perturbed instantiation of the trained neural network.

In some instances, such stochastic/random perturbation of the internal parameters of a network copy can be based on a training loss curve (and/or a training loss surface) that is associated with the trained neural network. Indeed, as mentioned above, no matter the structure/architecture of the trained neural network and/or no matter the training paradigm applied to the trained neural network, the trained neural network can have internal parameters (e.g., weights, biases, convolutional kernels) that can have been updated and/or optimized during training based on a loss/reward/penalty computation. As those having ordinary skill in the art will appreciate, such loss/reward/penalty computations, when considered collectively over all the training epochs and/or training iterations undergone by the trained neural network, can be visualized as a curve (and/or surface, in some cases) and thus can be referred to as a loss curve (and/or a loss surface, as appropriate). As those having ordinary skill in the art will further appreciate, the iteratively optimized values of the internal parameters of the trained neural network can be considered as locally optimizing the loss curve (e.g., locally minimizing the curve, in the case of loss and/or penalty computations; and/or locally maximizing the curve, in the case of reward computations). In various aspects, the direction of internal parameters that would cause the largest absolute value change in the loss curve can be obtained by: computing the Hessian of the loss curve with respect to the internal parameters; computing the maximum eigen value of that Hessian; and computing the eigen vector corresponding to that maximum eigen value. In other words, such eigen vector can be considered as denoting the direction (e.g., along the various axes that span the internal parameters) of greatest change in the loss curve. In various cases, the above-described Hessian technique is a mere non-limiting example of how the direction of greatest change in the loss curve can be evaluated. In various instances, any other suitable mathematical technique can be implemented to determine the direction of greatest change.

In any case, the perturbation component can evaluate and/or otherwise identify three points along the loss curve: a first training loss achieved at the optimized values of the internal parameters of the trained neural network; a second training loss achieved at values of the internal parameters that are displaced from the optimized values by any suitable distance in the direction of greatest change of the loss curve; and/or a third training loss achieved at values of the internal parameters that are displaced from the optimized values by that same distance in a direction opposite to the direction of greatest change of the loss curve. In various cases, the perturbation component can fit a parabola to such three points. In various aspects, the perturbation component can identify two locations on that parabola at which the parabola exhibits an absolute value slope of 1. In various instances, the one of those two identified locations on the parabola which is closer/nearer, in terms of abscissa distance, to the optimized internal parameter values can be considered as defining, denoting, and/or otherwise delineating a radius of a neighborhood (e.g., an interval and/or range) of internal parameter values. In various cases, for any given network copy, the perturbation component can stochastically and/or randomly change, adjust, and/or otherwise modify the internal parameters of that given network copy to be different from the optimized internal parameter values but to nevertheless be within the identified neighborhood. Thus, such neighborhood can, in some cases, be referred to as a perturbation neighborhood.

Accordingly, the perturbation component can, in various aspects, identify the perturbation neighborhood for the trained neural network based on the loss curve of the trained neural network, and/or the perturbation component can stochastically/randomly adjust the internal parameters of each of the set of network copies to be different from the optimized values but to nevertheless be within the perturbation neighborhood. The result of such stochastic/random perturbations can be the set of perturbed instantiations of the trained neural network.

Note that utilization of the loss curve does not require any specialized and/or unusual computations to have been performed during training of the trained neural network. In other words, no matter the architecture of the trained neural network and/or no matter the type of training applied to the trained neural network, training the trained neural network can always involve computing losses, penalties, and/or rewards across epochs/iterations, and the loss curve can be obtained from such computed losses/penalties/rewards. In still other words, it can usually/often be the case that the loss curve is available and/or otherwise known for the trained neural network. However, even in unusual instances where the loss curve is not available, the perturbation component can nevertheless stochastically/randomly perturb the internal parameter values of each of the set of network copies. For example, for a given network copy, the perturbation component can randomly edit the values of any suitable internal parameters of that given network copy within any suitable percentage range as desired (e.g., can shift an internal parameter value by ±3% or less). In such case, stochastic/randomized perturbations can be facilitated, even in the absence of the perturbation neighborhood (e.g., the percentage range can be considered as a rough estimation/proxy of the perturbation neighborhood).

In any case, the perturbation component can stochastically/randomly perturb the internal parameters of each of the set of network copies, thereby yielding the set of perturbed network instantiations.

In various embodiments, the inference component of the computerized tool can electronically generate an unperturbed prediction and/or a set of perturbed predictions, based on the trained neural network, based on the set of perturbed instantiations, and/or based on the data candidate. More specifically, in various aspects, the inference component can electronically execute the trained neural network on the data candidate, thereby causing the trained neural network to produce as output the unperturbed prediction. For example, the inference component can feed the data candidate to an input layer of the trained neural network, the data candidate can complete a forward pass through one or more hidden layers of the trained neural network, and/or an output layer of the trained neural network can compute the unperturbed prediction based on activation maps provided by the one or more hidden layers of the trained neural network. Likewise, the inference component can separately electronically execute each of the set of perturbed network instantiations on the data candidate, thereby causing the set of perturbed network instantiations to respectively produce the set of perturbed predictions. For instance, for any given perturbed network instantiation, the inference component can feed the data candidate to an input layer of the given perturbed network instantiation, the data candidate can complete a forward pass through one or more hidden layers of the given perturbed network instantiation, and/or an output layer of the given perturbed network instantiation can compute the unperturbed prediction based on activation maps provided by the one or more hidden layers of the given perturbed network instantiation. In any case, the unperturbed prediction and the set of perturbed predictions can all exhibit the same format and/or dimensionality as each other (e.g., can all be classification labels, can all be segmentation masks, can all be denoised images).

In various embodiments, the uncertainty component of the computerized tool can electronically generate an uncertainty indicator, based on the unperturbed prediction and/or the set of perturbed predictions. More specifically, the uncertainty indicator can be equal to, and/or otherwise based on, a standard deviation of the unperturbed prediction and the set of perturbed predictions. More specifically, still, because the unperturbed prediction and the set of perturbed predictions can all exhibit the same format and/or dimensionality as each other, the uncertainty component can group the unperturbed prediction and the set of perturbed predictions together, and the uncertainty component can compute element-wise standard deviations across such group. That is, the uncertainty indicator can exhibit the same format and/or dimensionality as the unperturbed prediction and/or as each of the set of perturbed predictions. For example, suppose that each of the unperturbed prediction and the set of perturbed predictions is an a-element vector, for any suitable positive integer a. That is, each of the unperturbed prediction and the set of perturbed predictions can be a vector having a first element to an a-th element. In such case, the uncertainty indicator can likewise be an a-element vector, where the first element of the uncertainty indicator can be equal to (and/or otherwise based on) the standard deviation of all of the first elements in the unperturbed prediction and the set of perturbed predictions, and where the a-th element of the uncertainty indicator can be equal to (and/or otherwise based on) the standard deviation of all of the a-th elements in the unperturbed prediction and the set of perturbed predictions.

In any case, because the uncertainty indicator can be equal to and/or otherwise based on a standard deviation of the unperturbed prediction and the set of perturbed predictions, the uncertainty indicator can be considered as quantifying how much agreement and/or how much disagreement there is with respect to the data candidate among the trained neural network and the set of perturbed instantiations of the trained neural network (e.g., can be considered as quantifying how similar and/or how dissimilar the unperturbed prediction and the set of perturbed predictions are with respect to each other). More agreement (e.g., lower standard deviation values in the uncertainty indicator) can be considered as indicating more confidence and/or less uncertainty, whereas less agreement (e.g., larger standard deviation values in the uncertainty indicator) can be considered as indicating less confidence and/or more uncertainty. In other words, if the uncertainty indicator contains large and/or high-magnitude standard deviation values, this can indicate that small changes (e.g., perturbations) to the internal parameters of the trained neural network caused disproportionately large changes in predicted/inferred output, which can be considered as a sign of high network uncertainty and/or low network confidence with respect to the data candidate. In contrast, if the uncertainty indicator instead contains small and/or low-magnitude standard deviation values, this can indicate that small changes (e.g., perturbations) to the internal parameters of the trained neural network caused commensurately small changes in predicted/inferred output, which can be considered as a sign of low network uncertainty and/or high network confidence with respect to the data candidate.

Although the herein disclosure mainly describes the uncertainty indicator as being based on standard deviation, this is a mere non-limiting example. In various cases, the uncertainty indicator can be computed by applying any other suitable statistical techniques to the unperturbed prediction and the set of perturbed predictions.

In any case, the uncertainty indicator can be considered as quantifying, conveying, and/or otherwise representing with how much confidence and/or uncertainty the trained machine learning model can analyze the data candidate (and/or portions of the data candidate).

In various embodiments, the execution component of the computerized tool can electronically initiate and/or facilitate any suitable electronic actions based on the uncertainty indicator. For example, in some cases, the execution component of the computerized tool can electronically render the uncertainty indicator on any suitable computer screen/display/monitor. Accordingly, the uncertainty indicator can be visually inspected by a user and/or operator (e.g., a medical professional) to aid and/or guide a decision (e.g., a medical diagnostic/prognostic decision) to be made by the user/operator. As another example, in some cases, the execution component of the computerized tool can electronically compare the uncertainty indicator to any suitable threshold and/or thresholds. If the uncertainty indicator fails to satisfy the threshold and/or thresholds, the execution component can electronically generate and/or transmit to any suitable computing device an electronic message stating that the trained neural network is not capable of analyzing the data candidate with sufficient confidence/certainty. In other cases, if the uncertainty indicator fails to satisfy the threshold and/or thresholds, the execution component can electronically generate and/or transmit to any suitable computing device an electronic message stating that, because the trained neural network exhibits excessive uncertainty with respect to the data candidate, manual review of the data candidate by a subject matter expert (e.g., a medical professional) is warranted and/or recommended. In yet other cases, if the uncertainty indicator fails to satisfy the threshold and/or thresholds, the execution component can electronically generate and/or transmit to any suitable computing device an electronic message stating that, because the trained neural network exhibits excessive uncertainty with respect to the data candidate, the data candidate should be re-captured/re-generated according to a modified acquisition protocol (e.g., if the data candidate is a CT scanned image that was captured according to a given radiation/voltage level and/or according to a given reconstruction kernel, then the electronic message can recommend that the data candidate be re-captured according to a different radiation/voltage level and/or a different reconstruction kernel). Indeed, in various aspects, the execution component can utilize and/or leverage the uncertainty indicator for any other suitable tasks as desired (e.g., the uncertainty indicator can be used, with and/or instead of accuracy, to drive neural network compression; the uncertainty indicator can be used, with and/or instead of accuracy, to select one neural network from a zoo/vault of trained neural networks).

Note that the computerized tool can generate the uncertainty indicator, regardless of the specific architecture of the trained neural network and/or regardless of the specific type of training applied to the trained neural network. Again, no matter how many and/or what types of layers the trained neural network includes, no matter why types of activation functions the trained neural network includes, no matter what types and/or arrangements of interneuron connections the trained neural network includes, no matter what type of training the trained neural network undergoes, and/or no matter what specific training dataset the trained neural network is trained on, the trained neural network can be considered as having internal parameters (e.g., weight matrices, bias vectors, convolutional kernels) whose values have been iteratively optimized during training, and the uncertainty indicator can be obtained by stochastically/randomly perturbing those internal parameter values. In other words, dropout layers/neurons are not required to compute the uncertainty indicator, unlike MCMC dropout techniques. Furthermore, specialized training procedures are not required to compute the uncertainty indicator, unlike SWAG techniques. Further still, prior knowledge of the specific training dataset is not required to compute the uncertainty indicator, unlike Test-Time Augmentation techniques. Accordingly, the technique described herein (e.g., stochastic perturbation of internal parameters) for facilitating uncertainty scoring can be considered as being generalizable across all neural network architectures and/or across all neural network training paradigms.

Moreover, note that the computerized tool can generate the uncertainty indicator without requiring excessive computational complexity and/or excessive consumption of computational resources. Indeed, as described herein, the trained neural network can undergo training, thereby yielding optimized internal parameter values, and the uncertainty indicator can be obtained by stochastically perturbing such optimized internal parameter values multiple times (e.g., to create the set of perturbed network instantiations). In particular, it must be emphasized that the stochastic perturbation of already-optimized internal parameters can be much less computationally intensive as compared to optimizing, from scratch during a training process, randomly-initialized internal parameters. Accordingly, even though computation of the uncertainty indicator as described herein can involve generating the set of perturbed network instantiations, the generation of any single one of the set of perturbed network instantiations can be considered as not computationally difficult, since each perturbed network instantiation can begin with the already-optimized internal parameters of the trained neural network. Contrast this Deep Ensemble techniques, that involve independently training multiple, randomly-initialized neural networks. In other words, the techniques described herein can be considered as involving only one computationally expensive phase (e.g., training of the trained neural network) and multiple computationally inexpensive phases (e.g., multiple perturbations, multiple neural network executions); in stark contrast, Deep Ensemble techniques involve multiple computationally expensive phases (e.g., separately training many randomly-initialized neural networks) and multiple computationally inexpensive phases (e.g., multiple neural network executions). Accordingly, the technique described herein (e.g., stochastic perturbation of internal parameters) for facilitating uncertainty scoring can be considered as being less computationally expensive than Deep Ensemble techniques (e.g., since stochastic perturbation does not require duplicative training phases, unlike Deep Ensemble techniques).

Therefore, various embodiments described herein can be considered as a computerized tool that can facilitate improved uncertainty scoring for neural networks via stochastic weight perturbations. In particular, such improved uncertainty scoring can be performed via the application of stochastic perturbations to internal parameters of an already-trained neural network. Such uncertainty scoring can be considered as improved as compared to existing techniques, since it can be agnostic to network architecture, agnostic to training paradigm, and computationally inexpensive.

Various embodiments described herein can be employed to use hardware and/or software to solve problems that are highly technical in nature (e.g., to facilitate improved uncertainty scoring for neural networks via stochastic weight perturbations), that are not abstract and that cannot be performed as a set of mental acts by a human. Further, some of the processes performed can be performed by a specialized computer (e.g., a trained neural network having internal parameters such as weight matrices, bias vectors, and/or convolutional kernels) for carrying out defined tasks related to improved uncertainty scoring for neural networks via stochastic weight perturbations. For example, such defined tasks can include: accessing, by a device operatively coupled to a processor, a trained neural network and a data candidate on which the trained neural network is to be executed; and generating, by the device, an uncertainty indicator representing how confidently executable or how unconfidently executable the trained neural network is with respect to the data candidate, based on a set of perturbed instantiations of the trained neural network. In various aspects, such defined tasks can further include: generating, by the device, the set of perturbed instantiations of the trained neural network, by randomly perturbing internal parameters of the trained neural network; and generating, by the device, a set of perturbed predictions, by respectively executing the set of perturbed instantiations of the trained neural network on the data candidate, wherein respective ones of the set of perturbed instantiations receive as input the data candidate and produce as output respective ones of the set of perturbed predictions, and wherein the uncertainty indicator is based on a standard deviation of the set of perturbed predictions.

Such defined tasks are not performed manually by humans. Indeed, neither the human mind nor a human with pen and paper can electronically access a neural network that has already been trained and a data candidate (e.g., a two-dimensional pixel array, a three-dimensional voxel array, a timeseries tensor, waveform data), electronically and stochastically perturb/adjust internal parameters of the neural network to create a set of perturbed versions of the neural network, electronically execute the neural network and the set of perturbed versions on the data candidate, and electronically compute a standard deviation of the results produced by the neural network and the set of perturbed versions. Instead, various embodiments described herein are inherently and inextricably tied to computer technology and cannot be implemented outside of a computing environment (e.g., a neural network is an inherently-computerized construct that simply cannot be implemented in any way by the human mind without computers; accordingly, a computerized tool that perturbs and/or executes a neural network is likewise inherently-computerized and cannot be implemented in any sensible, practical, or reasonable way without computers).

Moreover, various embodiments described herein can integrate into a practical application various teachings relating to improved uncertainty scoring for neural networks via stochastic weight perturbations. As explained above, existing techniques for facilitating uncertainty scoring suffer from various significant disadvantages. Specifically, some techniques (e.g., MCMC dropout) can be applied only to neural networks with very specific structures (e.g., only neural networks that have built-in dropout layers) and are thus not generalizable. Moreover, other techniques (e.g., SWAG techniques) can be applied only to neural networks that have been trained in a very specific fashion (e.g., where means and/or covariance matrices of internal parameters had been computed at each training epoch) and are thus also not generalizable. Furthermore, still other techniques (e.g., Test-Time Augmentation) can be applied only to neural networks for which the specific content of the training dataset is known (e.g., meaningful augmentations to apply to input data cannot be determined if the augmentations that were already-present in the training dataset are not known). Further still, yet other techniques (e.g., Deep Ensemble techniques) consume extremely many computational resources (e.g., require duplicative training, from scratch, of several randomly-initialized neural networks).

In stark contrast, various embodiments described herein can address these technical problems. Specifically, various embodiments described herein can involve: randomly perturbing the internal parameters of an already-trained neural network, thereby yielding a set of perturbed instantiations of the already-trained neural network; executing the already-trained neural network and each of the perturbed instantiations on a data candidate; and computing a standard deviation of the outputs produced by the already-trained neural network and each of the perturbed instantiations, where such standard deviation can be considered as quantifying how confidently executable and/or how unconfidently executable the already-trained neural network is with respect to the data candidate. Such technique can be applied, no matter how many and/or what types of layers the already-trained neural network has, no matter how many neurons and/or what types of activation functions the already-trained neural network has, no matter the types and/or arrangement of interneuron connections of the already-trained neural network, no matter how the already-trained neural network was trained, and/or no matter the content of the training data on which the already-trained neural network was trained. Accordingly, such technique can be considered as being generalizable across neural network architectures and/or across training paradigms. Furthermore, because stochastically perturbing already-optimized internal parameters can be much less computationally expensive than training randomly-initialized internal parameters from scratch, such technique can be considered as much less computationally intensive as compared to techniques that involve training multiple networks. A computerized tool that can implement such technique certainly constitutes a concrete and tangible technical improvement in the field of neural networks. Therefore, various embodiments described herein clearly qualify as useful and practical applications of computers.

Furthermore, various embodiments described herein can control real-world tangible devices based on the disclosed teachings. For example, various embodiments described herein can electronically perturb/adjust the real-world internal parameters of real-world neural networks, can electronically execute such real-world neural networks, and/or can electronically render real-world results, messages, and/or images on real-world computer screens based on such execution of such real-world neural networks.

It should be appreciated that the herein figures and description provide non-limiting examples of various embodiments and are not necessarily drawn to scale.

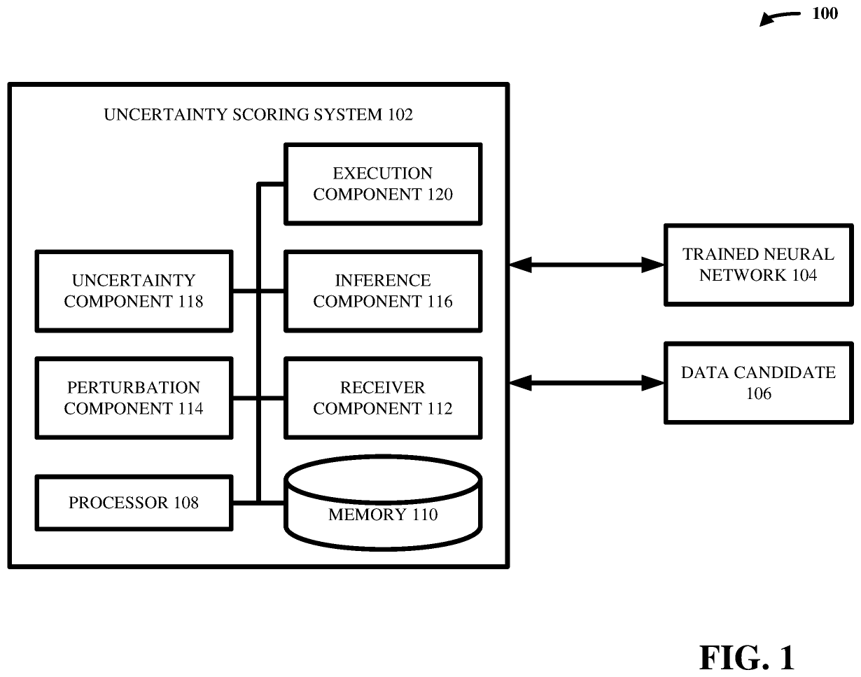

FIG. 1 illustrates a block diagram of an example, non-limiting system 100 that can facilitate improved uncertainty scoring for neural networks via stochastic weight perturbations in accordance with one or more embodiments described herein. In various embodiments, as shown, an uncertainty scoring system 102 can be electronically integrated, via any suitable wired and/or wireless electronic connections, with a trained neural network 104 and/or with a data candidate 106.

In various embodiments, the data candidate 106 can be any suitable type and/or piece of electronic data that can exhibit any suitable format and/or dimensionality. In other words, the data candidate 106 can be one or more scalars, one or more vectors of any suitable sizes, one or more matrices of any suitable sizes, one or more tensors of any suitable sizes, one or more character strings of any suitable lengths, and/or any suitable combination thereof. As a non-limiting example, the data candidate 106 can be a two-dimension pixel array and/or a three-dimensional voxel array that depicts any suitable object and/or portion thereof as desired (e.g., can be a medical image that visually depicts one or more anatomical structures of one or more medical patients; can be a vehicular image that visually depicts a roadway and/or traffic on the roadway; can be a nautical image that visually depicts a waterway and/or traffic on the waterway; can be an aircraft image that visually depicts an airway and/or traffic in the airway; can be a security camera image that visually depicts a walkway/room and/or foot traffic in the walkway/room). As another non-limiting example, the data candidate 106 can be a vector, matrix, and/or tensor of timeseries data values (e.g., can chronologically convey measured pressure values, measured temperature values, measured humidity values, measured deflection values, measured voltage values, measured amperage values, measured capacitance values, measured resistance values, measured inductance values, measured impedance values, measured heartrate values, measured breathing rate values, measured weight values, measured chemical concentration values, and/or measured auditory volume values). As yet another non-limiting example, the data candidate 106 can be a vector, matrix, and/or tensor of any other suitable data as desired (e.g., can be a vector, matrix, and/or tensor that represents a transactional history of an e-commerce customer, that represents product/service preferences of the e-commerce customer, and/or that represents financial instrument information of the e-commerce customer).

In any case, the data candidate 106 can have been captured and/or generated by any suitable equipment and/or computerized devices (not shown) as desired. As a non-limiting example, if the data candidate 106 is a two-dimensional pixel array and/or a three-dimensional voxel array, then the data candidate 106 can have been captured/generated by any suitable imaging modalities (e.g., captured/generated by a CT scanner, captured/generated by an MM scanner, captured/generated by an X-ray scanner, captured/generated by an ultrasound scanner, captured/generated by a PET scanner, captured/generated by a visible spectrum camera/video-camera mounted on/in a terrestrial vehicle, captured/generated by a visible spectrum camera/video-camera mounted on/in a marine vehicle, captured/generated by a visible spectrum camera/video-camera mounted on/in an air vehicle; captured/generated by a visible spectrum camera/video-camera mounted on/in a building). As another non-limiting example, if the data candidate 106 is timeseries data, then the data candidate 106 can have been captured/generated by any suitable measurement devices (e.g., pressure sensors, temperature tensors, humidity sensors, strain sensors, voltage sensors, amperage sensors, capacitance sensors, resistance sensors, inductance sensors, impedance sensors, heartrate sensors, breathing-rate sensors, weight sensors, chemical sensors, and/or microphones). As still another non-limiting example, the data candidate 106 can have been manually generated via user-provided input.

In various embodiments, the trained neural network 104 can exhibit any suitable deep learning neural network architecture as desired. As a non-limiting example, the trained neural network 104 can include any suitable types and/or numbers of layers. That is, the trained neural network 104 can include any suitable input layer, any suitable number of hidden layers, and/or any suitable output layer, any of which can be convolutional layers, batch normalization layers, pooling layers, downsampling layers, upsampling layers, and/or any other suitable types of layers as desired. Moreover, the trained neural network 104 can include any suitable numbers of neurons in various layers. That is, different layers can have the same and/or different numbers of neurons as each other. Furthermore, the trained neural network 104 can include any suitable activation functions, such as softmax, sigmoid, hyperbolic tangent, and/or rectified linear unit, in various neurons. That is, different neurons can have the same and/or different activation functions as each other. Further still, the trained neural network 104 can include any suitable interneuron connections, such as forward connections, skip connections, and/or recurrent connections, arranged in any suitable layout as desired.

In any case, the trained neural network 104 can be configured to be executable on the data candidate 106. More specifically, the layers of the trained neural network 104 can be configured to receive as input the data candidate 106 and to produce as output a prediction pertaining to the data candidate 106. In various instances, the prediction can exhibit any suitable format and/or dimensionality as desired. That is, the prediction can be one or more scalars, one or more vectors of any suitable sizes, one or more matrices of any suitable sizes, one or more tensors of any suitable sizes, one or more character strings of any suitable lengths, and/or any suitable combination thereof. As a non-limiting example, in some cases, the prediction can be a classification label corresponding to the data candidate 106. As another non-limiting example, the prediction can be a segmentation mask corresponding to the data candidate 106. As yet another non-limiting example, the prediction can be an edited, denoised, enhanced, and/or otherwise transformed version of the data candidate 106.

In various aspects, the trained neural network 104 can have experienced any suitable type and/or paradigm of training. As a non-limiting example, the trained neural network 104 can have undergone supervised training based on an annotated training dataset. As those having ordinary skill in the art will appreciate, such supervised training can involve: random initialization of internal parameters of the trained neural network 104; feeding the trained neural network 104 training data candidates from the annotated training dataset; computing losses/errors between the results outputted by the trained neural network 104 and ground-truth annotations that correspond to the inputted training data candidates; and iteratively updating the internal parameters of the trained neural network 104 via backpropagation driven by such computed losses/errors. As those having ordinary skill in the art will further appreciate, such supervised training can involve any suitable training batch sizes, any suitable training termination criteria, and/or any suitable error/loss/objective functions. As another non-limiting example, the trained neural network 104 can have experienced unsupervised trained based on an unannotated training dataset. As yet another non-limiting example, the trained neural network 104 can have experienced reinforcement training based on iterative rewards and/or penalties. In various cases, the uncertainty scoring system 102 can have facilitated any of such training types and/or paradigms on the trained neural network 104.

In any case, the trained neural network 104 can have internal parameters, such as weight matrices, bias vectors, and/or convolutional kernels, whose values/magnitudes can have been updated and/or optimized during training, where such updates and/or optimizations can have been based on any suitable loss/penalty computations.

In various aspects, it can be desired to determine a level of confidence and/or uncertainty with which the trained neural network 104 can analyze (e.g., can be executed on) the data candidate 106. As described herein, the uncertainty scoring system 102 can facilitate such determination.

In various embodiments, the uncertainty scoring system 102 can comprise a processor 108 (e.g., computer processing unit, microprocessor) and a computer-readable memory 110 that is operably and/or operatively and/or communicatively connected/coupled to the processor 108. The computer-readable memory 110 can store computer-executable instructions which, upon execution by the processor 108, can cause the processor 108 and/or other components of the uncertainty scoring system 102 (e.g., receiver component 112, perturbation component 114, inference component 116, uncertainty component 118, execution component 120) to perform one or more acts. In various embodiments, the computer-readable memory 110 can store computer-executable components (e.g., receiver component 112, perturbation component 114, inference component 116, uncertainty component 118, execution component 120), and the processor 108 can execute the computer-executable components.

In various embodiments, the uncertainty scoring system 102 can comprise a receiver component 112. In various aspects, the receiver component 112 can electronically receive and/or otherwise electronically access the trained neural network 104 and/or the data candidate 106. In various instances, the receiver component 112 can electronically retrieve the trained neural network 104 and/or the data candidate 106 from any suitable centralized and/or decentralized databases and/or data structures (not shown). In any case, the receiver component 112 can electronically obtain and/or access the trained neural network 104 and/or the data candidate 106, such that other components of the uncertainty scoring system 102 can electronically interact with the trained neural network 104 and/or with the data candidate 106.

In various embodiments, the uncertainty scoring system 102 can further comprise a perturbation component 114. In various aspects, as described herein, the perturbation component 114 can electronically generate a set of perturbated instantiations of the trained neural network 104.

In various embodiments, the uncertainty scoring system 102 can further comprise an inference component 116. In various instances, as described herein, the inference component 116 can electronically generate an unperturbed prediction and/or a set of perturbed predictions, based on the data candidate 106, based on the trained neural network 104, and/or based on the set of perturbed instantiations created by the perturbation component 114.

In various embodiments, the uncertainty scoring system 102 can further comprise an uncertainty component 118. In various cases, as described herein, the uncertainty component 118 can electronically generate an uncertainty indicator, based on the unperturbed prediction and/or based on the set of perturbed predictions produced by the inference component 116.

In various embodiments, the uncertainty scoring system 102 can further comprise an execution component 120. In various aspects, the execution component 120 can electronically facilitate and/or initiate any suitable electronic actions, based on the uncertainty indicator produced by the uncertainty component 118.

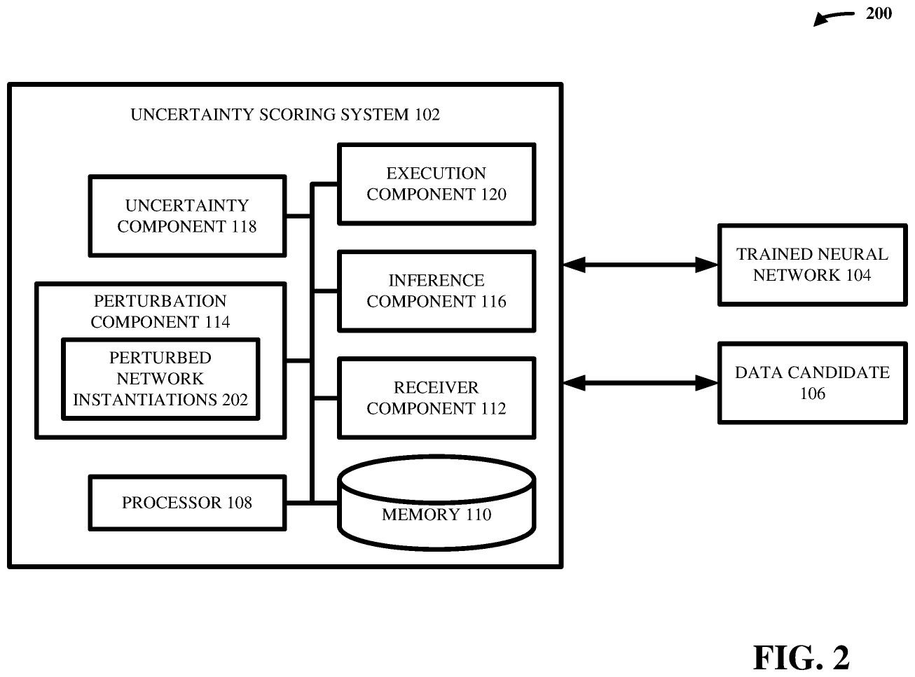

FIG. 2 illustrates a block diagram of an example, non-limiting system 200 including a set of perturbed network instantiations that can facilitate improved uncertainty scoring for neural networks via stochastic weight perturbations in accordance with one or more embodiments described herein. As shown, the system 200 can, in some cases, comprise the same components as the system 100, and can further comprise a set of perturbed network instantiations 202.

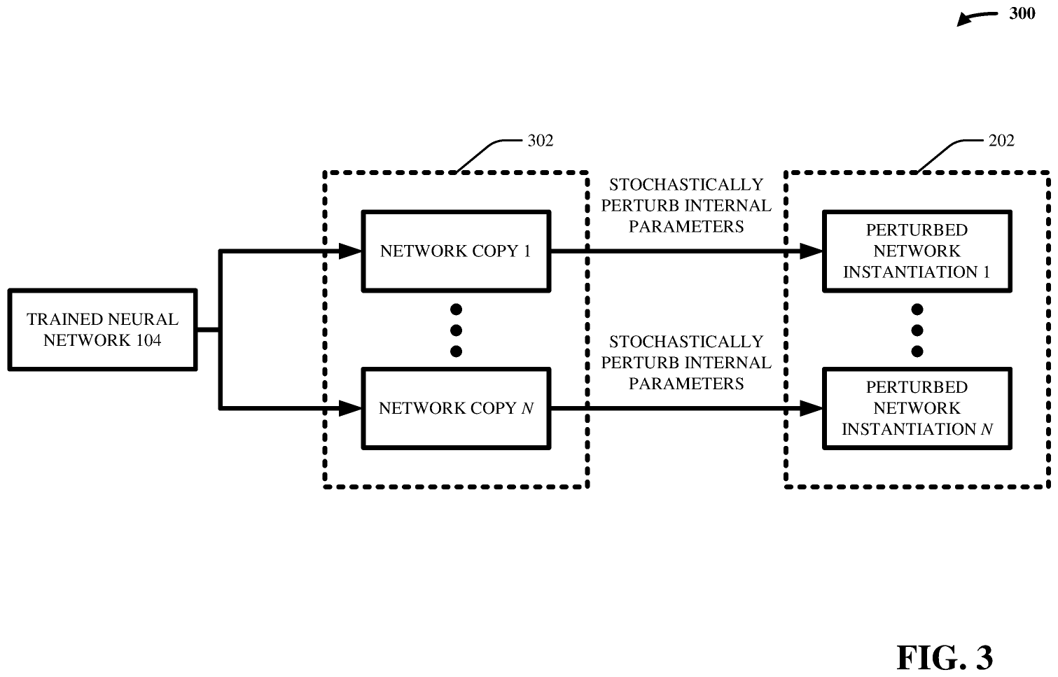

In various embodiments, the perturbation component 114 can electronically generate the set of perturbed network instantiations 202, based on the trained neural network 104. More specifically, the perturbation component 114 can electronically generate a set of perturbed versions of the trained neural network 104, by applying stochastic and/or random perturbations to the internal parameters of the trained neural network 104. This is described more with respect to FIG. 3.

FIG. 3 illustrates an example, non-limiting block diagram 300 showing how the set of perturbed network instantiations 202 can be generated in accordance with one or more embodiments described herein.

In various embodiments, as shown, the perturbation component 114 can electronically create a set of network copies 302 based on the trained neural network 104. In various aspects, the set of network copies 302 can include n network copies, for any suitable positive integer n: a network copy 1 to a network copy n. In any case, each of the set of network copies 302 can be an identical copy of, an identical duplication of, and/or an identical replica of the trained neural network 104. Accordingly, each of the set of network copies 302 can have the same architecture and/or internal parameter values as the trained neural network 104. For example, the network copy 1 can be a copy of, a duplication of, and/or a replica of the trained neural network 104. Accordingly, the network copy 1 can have: the same numbers, types, and/or arrangement of layers as the trained neural network 104; the same types and/or arrangement of interneuron connections as the trained neural network 104; the same weight matrices as the trained neural network 104; the same bias vectors as the trained neural network 104; and/or the same convolutional kernels as the trained neural network 104. As another example, the network copy n can be a copy of, a duplication of, and/or a replica of the trained neural network 104. Thus, as above, the network copy n can have: the same numbers, types, and/or arrangement of layers as the trained neural network 104; the same types and/or arrangement of interneuron connections as the trained neural network 104; the same weight matrices as the trained neural network 104; the same bias vectors as the trained neural network 104; and/or the same convolutional kernels as the trained neural network 104. In other words, the perturbation component 114 can be considered as copying the trained neural network 104 n times.

In various aspects, as shown, the perturbation component 114 can electronically generate the set of perturbed network instantiations 202 based on the set of network copies 302. In various instances, the set of perturbed network instantiations 202 can respectively correspond (e.g., in one-to-one fashion) to the set of network copies 302. Thus, because the set of network copies 302 can include n copies, the set of perturbed network instantiations 202 can include n instantiations: a perturbed network instantiation 1 to a perturbed network instantiation n. In various cases, the perturbation component 114 can electronically generate the set of perturbed network instantiations 202 by applying stochastic/random perturbations to the internal parameters of respective ones of the set of network copies 302.

As a non-limiting example, the perturbed network instantiation 1 can correspond to the network copy 1. That is, in various aspects, the perturbation component 114 can create, generate, and/or otherwise produce the perturbed network instantiation 1 by stochastically/randomly perturbing the internal parameters (e.g., the weight matrix values, the bias vector values, the convolutional kernel values) of the network copy 1. Accordingly, the perturbed network instantiation 1 can be considered as having the same numbers, types, and/or arrangement of layers as the network copy 1 (and thus as the trained neural network 104) and as having the same types and/or arrangement of interneuron connections as the network copy 1 (and thus as the trained neural network 104), but as having different internal parameter values (e.g., different weight matrix values, different bias vector values, different convolutional kernel values) as compared to the network copy 1 (and thus as compared to the trained neural network 104). In other words, the perturbed network instantiation 1 can be considered as a first version of the trained neural network 104 that has perturbed (e.g., slightly modified) internal parameters.

As another non-limiting example, the perturbed network instantiation n can correspond to the network copy n. That is, in various aspects, the perturbation component 114 can create, generate, and/or otherwise produce the perturbed network instantiation n by stochastically/randomly perturbing the internal parameters (e.g., the weight matrix values, the bias vector values, the convolutional kernel values) of the network copy n. Accordingly, the perturbed network instantiation n can be considered as having the same numbers, types, and/or arrangement of layers as the network copy n (and thus as the trained neural network 104) and as having the same types and/or arrangement of interneuron connections as the network copy n (and thus as the trained neural network 104), but as having different internal parameter values (e.g., different weight matrix values, different bias vector values, different convolutional kernel values) as compared to the network copy n (and thus as compared to the trained neural network 104). Thus, the perturbed network instantiation n can be considered as an n-th version of the trained neural network 104 that has perturbed (e.g., slightly modified) internal parameters.

In various cases, due to the stochasticity and/or randomness with which the perturbation component 114 can generate the set of perturbed network instantiations 202, each of the set of perturbed network instantiations 202 can have different and/or unique internal parameters as compared to each other. For example, the perturbed network instantiation 1 can have internal parameter values that are different from and/or otherwise not identical to those of any other instantiation in the set of perturbed network instantiations 202. Likewise, the perturbed network instantiation n can have internal parameter values that are different from and/or otherwise not identical to those of any other instantiation in the set of perturbed network instantiations 202.

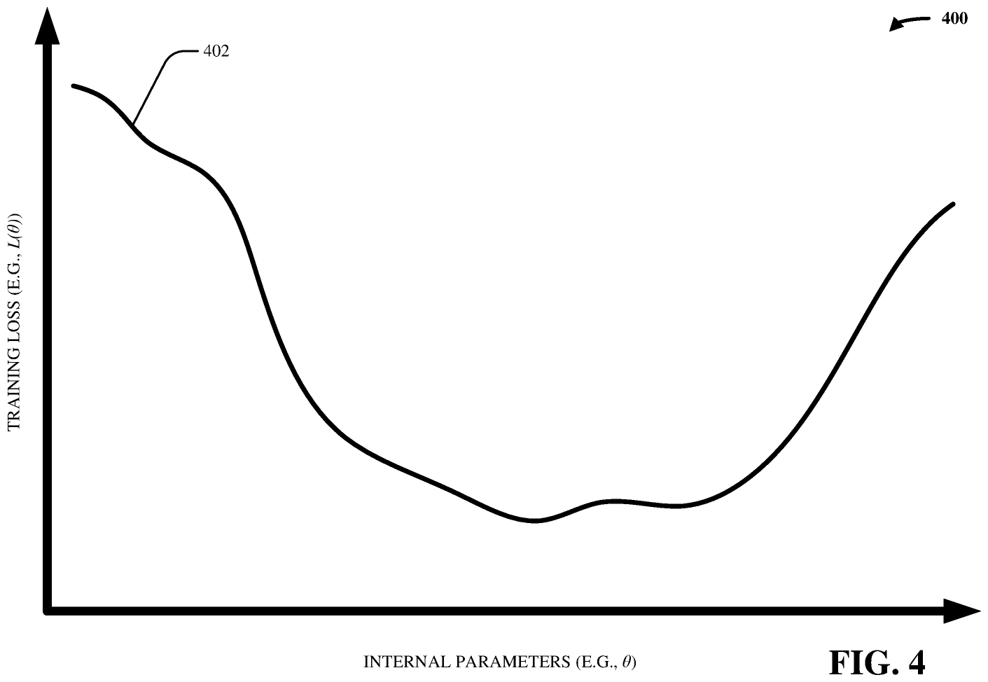

In any case, the trained neural network 104 can be considered as having optimized (and/or approximately optimized) internal parameter values due to the training undergone by the trained neural network 104, and each of the set of perturbed network instantiations 202 can be considered as having internal parameter values that are slightly modified and/or slightly different from those optimized values. In various aspects, as mentioned above, such slightly modified and/or slightly different internal parameter values can be obtained via stochastic and/or randomized perturbations. In some instances, such stochastic and/or randomized perturbations can be facilitated based on a training loss curve and/or a training loss surface associated with the trained neural network 104. This is explained in more detail with respect to FIGS. 4-7.

FIGS. 4-7 illustrate example, non-limiting graphs 400, 500, 600, and 700 further explaining how the set of perturbed network instantiations 202 can be generated in accordance with one or more embodiments described herein. In particular, FIGS. 4-7 help to explain how a training loss curve of the trained neural network 104 can be leveraged to generate the set of perturbed network instantiations 202.

First, consider FIG. 4. In various aspects, as shown, the graph 400 of FIG. 4 depicts a non-limiting example of a training loss curve 402 that can correspond to the trained neural network 104. As those having ordinary skill in the art will appreciate, the training loss curve 402 can be considered as representing how the training loss (e.g., as computed by any suitable error function, loss function, objective function, and/or penalty function) of the trained neural network 104 changed in response to iterative updates made during training to the values of the internal parameters of the trained neural network 104.

In particular, an abscissa (e.g., x-axis) of the graph 400 can represent and/or span different internal parameter configurations, and/or an ordinate (e.g., y-axis) of the graph 400 can represent and/or span different training loss values. For ease of explanation and/or illustration, any given configuration of internal parameter values can be denoted as θ, and/or any given training loss value, which can be a function of θ, can be denoted as L(θ). As those having ordinary skill in the art will appreciate, θ can be considered as a multi-dimensional variable (e.g., can be one or more vectors, one or more matrices, and/or one or more tensors) that represents weight values, bias values, convolutional kernel values, and/or any other suitable internal parameter values of the trained neural network 104 that are configurable, learnable, and/or otherwise updatable during training, whereas L(θ) can be a scalar representing how much error θ has produced with respect to some inputted training data. As a non-limiting example, suppose that the trained neural network 104 has q internal parameter values that are configurable/updatable during training, for any suitable positive integer q where q can be the total and/or collective dimensional cardinality of all of the weight matrices, bias vectors, and/or convolutional kernels within the trained neural network 104. In such case, θ can be a q-dimensional quantity, and L(θ) can be a one-dimensional scalar. As those having ordinary skill in the art will appreciate, q can, in some cases, be in the ten thousands, hundred thousands, and/or even millions.

Although FIG. 4 illustrates the training loss curve 402 as being plottable on a two-dimensional graph, this is a mere non-limiting example for ease of illustration/explanation. As those having ordinary skill in the art will appreciate, the training loss curve 402 can, in various instances and due to the multi-dimensional nature of θ, instead be considered as a training loss surface, as a training loss hypersurface, and/or as a training loss field. Thus, any suitable loss visualization and/or dimensional compression techniques can be applied accordingly.

In any case, as L(θ) approaches a minimum value, θ can be considered as approaching an optimized configuration of internal parameter values.

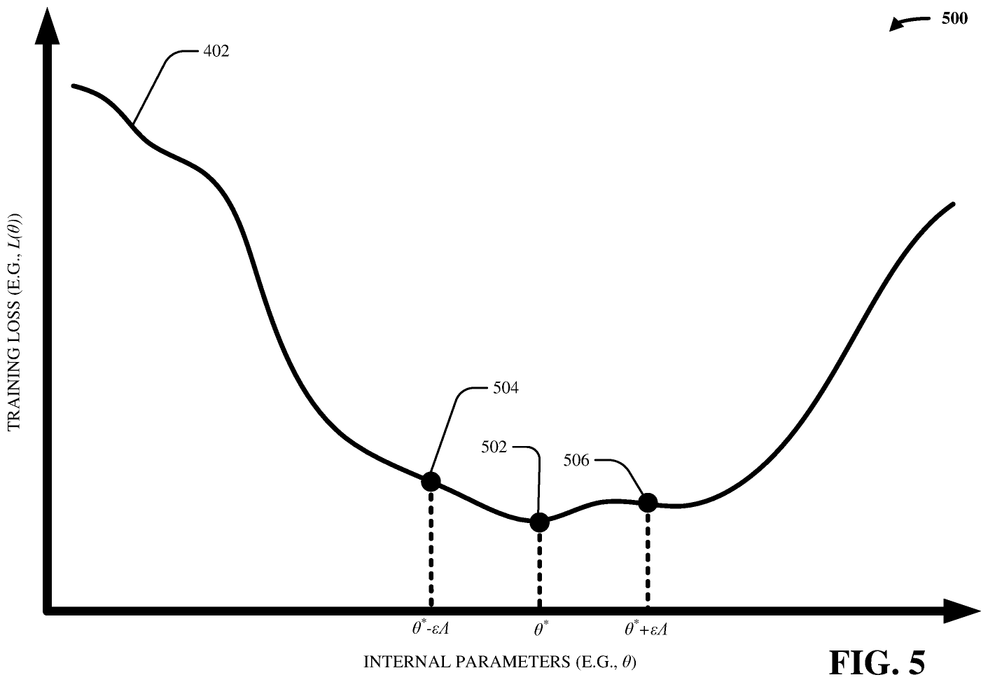

Next, consider FIG. 5. In various aspects, as shown, the graph 500 of FIG. 5 depicts the training loss curve 402 with three specific points called out: a point 502, a point 504, and/or a point 506. In various instances, as shown, the point 502 can be considered as representing a minimized (and/or approximately minimized) value of the training loss curve 402. In various cases, as also shown, the point 502 can be considered as corresponding to an internal parameter configuration denoted by θ*. In other words, when the internal parameters of the trained neural network 104 take on the values of θ*, the trained neural network 104 can be considered as exhibiting a lowest amount of training loss. Accordingly, θ* can, in some aspects, be referred to as an optimized (and/or approximately optimized) internal parameter configuration. In any case, because the trained neural network 104 can have already undergone training, the internal parameters of the trained neural network 104 can already be set to and/or otherwise in accordance with θ*.

In various aspects, the perturbation component 114 can electronically calculate a direction of greatest change of L(θ) at θ* (e.g., at the point 502), and such direction of greatest change can be denoted as Λ. More specifically, the perturbation component 114 can: calculate/estimate the Hessian of L(θ*); calculate/estimate the maximum eigen value of that Hessian; and/or calculate/estimate the eigen vector corresponding to that maximum eigenvalue. Accordingly, in various aspects, Λ can be equal to and/or otherwise based on that calculated/estimated eigen vector. As a non-limiting example, suppose again that the trained neural network 104 has a total of q internal parameter values. In such case, θ* can be a q-dimensional quantity, and Λ can be a q-dimensional vector whose elements indicate how respectively corresponding elements of θ* should be changed so as to cause a maximum increase in L(θ*). In some cases, the magnitude of Λ can be unity (e.g., that is, Λ can be normalized).

In various aspects, the perturbation component 114 can leverage A to identify/locate the point 504 and/or the point 506. More specifically, in various instances, the perturbation component 114 can select any suitable positive real number ε, the perturbation component 114 can subtract εΛ from θ*, the perturbation component 114 can identify which point on the training loss curve 402 corresponds to such difference, and/or such point can be considered as the point 504. In other words, the point 504 can be considered as being located along the abscissa at θ*−εΛ and along the ordinate at L(θ*−εΛ). Likewise, in various cases, the perturbation component 114 can add EA to θ*, the perturbation component 114 can identify which point on the training loss curve 402 corresponds to such sum, and/or such point can be considered as the point 506. That is, the point 506 can be considered as being located along the abscissa at θ*+εΛ and along the ordinate at L(θ*+εΛ). In various aspects, E can be a positive, real-valued scalar whose magnitude is less than 1 (e.g., E can be equal to 0.9999, can be equal to 0.0001, and/or can be equal to any suitable, positive, real-valued scalar in between and 0.0001).

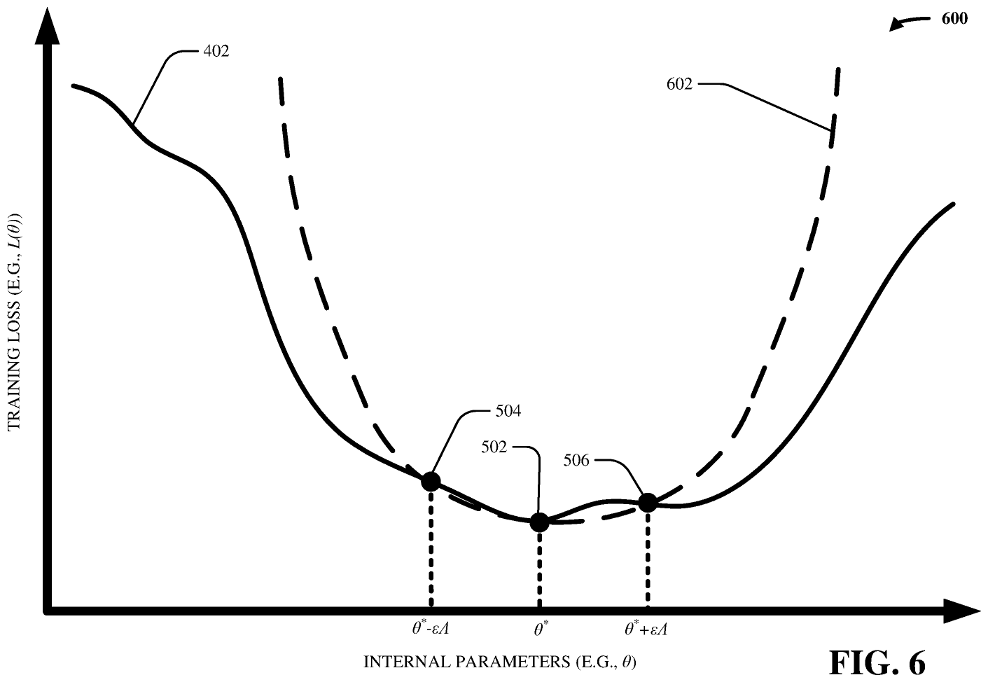

Now, consider FIG. 6. In various aspects, as shown, the graph 600 of FIG. 6 can depict the training loss curve 402, the point 502, the point 504, and/or the point 506. In various instances, as further shown, the perturbation component 114 can electronically fit a parabola 602 to the point 502, the point 504, and the point 506. Indeed, as those having ordinary skill in the art will appreciate, a parabola can be defined by three points in space. Accordingly, when given the point 502, the point 504, and the point 506, the perturbation component 114 can identify a parabola that passes through (e.g., that is fitted to) those three points, and such parabola can be referred to as the parabola 602. In some cases, the parabola 602 can be denoted as p(ε), which can indicate that the shape of the parabola 602 can depend upon (e.g., can be a function of) the value chosen for E.

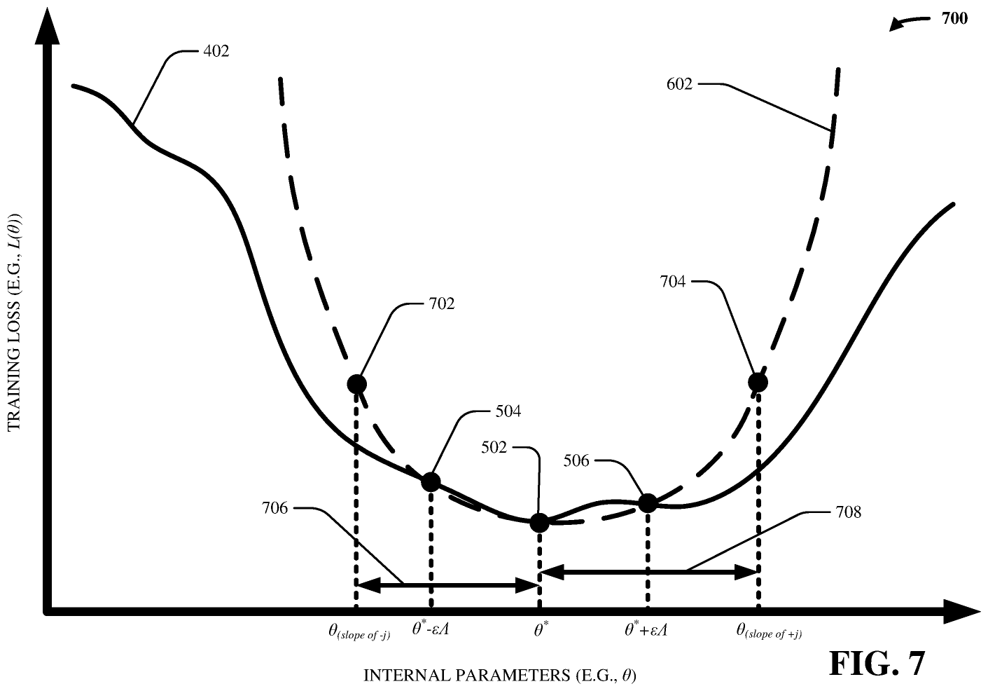

Next, consider FIG. 7. In various aspects, as shown, the graph 700 of FIG. 7 can depict the training loss curve 402, the point 502, the point 504, the point 506, and/or the parabola 602. In various instances, as further shown, the graph 700 can call out two additional points: a point 702 and a point 704. In various cases, the perturbation component 114 can identify on the parabola 602 a point at which the slope of the parabola 602 is −j, for any suitable positive real-number j. In some aspects, j can be equal to 1. In various instances, the identified point at which the slope of the parabola 602 is equal to −j can be referred to as the point 702. In various instances, as shown, the point 702 can be considered as corresponding to an internal parameter configuration denoted as θ_{(slope of -j)}. Similarly, in various cases, the perturbation component 114 can identify on the parabola 602 a point at which the slope of the parabola 602 is +j. In various aspects, the identified point at which the slope of the parabola 602 is equal to +j can be referred to as the point 704. In various instances, as shown, the point 704 can be considered as corresponding to an internal parameter configuration denoted as θ_{(slope of +j)}.

Next, the perturbation component 114 can measure an absolute value distance 706 between θ* and (slope of −j), and/or the perturbation component 114 can measure an absolute value distance 708 between θ* and θ_{(slope of +j)}. In various aspects, the perturbation component 114 can define a perturbation neighborhood based on the absolute value distance 706 and/or based on the absolute value distance 708. In particular, if the absolute value distance 706 is less than the absolute value distance 708, then the perturbation component 114 can define the perturbation neighborhood as ranging from θ_{(slope of -j)} to θ*+(θ*−θ_{(slope of -j)}). In contrast, if the absolute value distance 706 is greater than the absolute value distance 708, then the perturbation component 114 can define the perturbation neighborhood as ranging from θ*−(θ_{(slope of +j)}−θ*) to θ_{(slope of +j)} In other words, the perturbation component 114 can define the perturbation neighborhood as a range and/or interval of internal parameter configurations, where such range/interval can be centered about θ*, and/or where such range/interval can be considered as having a radius that is equal to the minimum absolute value abscissa-distance between θ* and a point on the parabola 602 having an absolute value slope equal to j.

The above technique involving computation of a maximum eigenvector of a Hessian and/or fitting of a parabola to the training loss curve 402 is a mere non-limiting example by which the perturbation component 114 can define and/or identify the perturbation neighborhood. In various other instances, the perturbation component 114 can define/identify the perturbation neighborhood in any other suitable fashion as desired (e.g., can define/identify the perturbation neighborhood based on any suitable relative change in the training loss curve 402 compared to any suitable local minimum of the training loss curve 402).

In any case, once the perturbation component 114 defines and/or identifies the perturbation neighborhood based on the training loss curve 402, the perturbation component 114 can stochastically/randomly perturb the internal parameters of each of the set of network copies 302 so as to be within the perturbation neighborhood. As a non-limiting example, consider again the network copy 1 and the perturbed network instantiation 1. As mentioned above, the perturbation component 114 can copy, duplicate, and/or replicate the trained neural network 104 a first time, thereby yielding the network copy 1. As also mentioned above, the perturbation component 114 can stochastically/randomly perturb the internal parameters of the network copy 1, thereby yielding the perturbed network instantiation 1. More specifically, after identifying the perturbation neighborhood as described with respect to FIGS. 4-7, the perturbation component 114 can randomly assign to the network copy 1 an internal parameter configuration that is different from θ* but that is nevertheless within the perturbation neighborhood. The result of such random/stochastic assignment can be the perturbed network instantiation 1.

As another non-limiting example, consider again the network copy n and the perturbed network instantiation n. As mentioned above, the perturbation component 114 can copy, duplicate, and/or replicate the trained neural network 104 an n-th time, thereby yielding the network copy n. As also mentioned above, the perturbation component 114 can stochastically/randomly perturb the internal parameters of the network copy n, thereby yielding the perturbed network instantiation n. In particular, after identifying the perturbation neighborhood as described with respect to FIGS. 4-7, the perturbation component 114 can randomly assign to the network copy n an internal parameter configuration that is different from θ* but that is nevertheless within the perturbation neighborhood. The result of such random/stochastic assignment can be the perturbed network instantiation n.

Because of such random/stochastic assignments, it can be likely that the internal parameter configurations respectively assigned to the set of network copies 302 can all be different from each other (e.g., it can be the case that the internal parameters of the perturbed network instantiation 1 are different from those of the perturbed network instantiation n).

Note that the perturbation component 114 can generate the set of perturbed network instantiations 202, regardless of the type of internal architecture of the trained neural network 104. That is, the perturbation component 114 does not require that the trained neural network 104 have specialized internal structural/architectures (e.g., dropout layers). Accordingly, the perturbation component 114 can be considered as being agnostic to the structure/architecture of the trained neural network 104.

Similarly, note that the perturbation component 114 can generate the set of perturbed network instantiations 202, regardless of the type of training applied to the trained neural network 104. That is, the perturbation component 114 does not require that specialized and/or unusual computations (e.g., covariance matrix computations assuming Gaussian weight distributions) be performed during training of the trained neural network 104. Accordingly, the perturbation component 114 can be considered as being agnostic to the training protocols undergone by the trained neural network 104.

Furthermore, note that the perturbation component 114 does not facilitate n separate/independent training phases in order to create the set of perturbed network instantiations 202. Instead, the perturbation component 114 can randomly/stochastically perturb n copies/replicas (e.g., 302) of the trained neural network 104. Stochastically/randomly perturbing one already-trained neural network n times is far, far less computationally expensive than separately/independently training n differently-initialized neural networks. Accordingly, the perturbation component 114 can be considered as not consuming excessively many computational resources.

Although FIG. 4-7 help to clarify how the perturbation component 114 can stochastically/randomly perturb the internal parameters of the trained neural network 104 based on the training loss curve 402, this is a mere non-limiting example for ease of illustration. In various aspects, every type of training (e.g., supervised, unsupervised, reinforcement) which the trained neural network 104 can undergo can involve the iterative computation of losses and/or penalties (and/or, equivalently, rewards) at each training epoch. Accordingly, every type of such training can involve creating a training loss curve (e.g., 402) for the trained neural network 104. Thus, it can often and/or usually be the case that the training loss curve 402 is available for use by the perturbation component 114. However, in some cases, it can nevertheless be possible that the training loss curve 402 is unavailable for some reason or another. Even in such cases, the perturbation component 114 can nevertheless generate the set of perturbed network instantiations 202.

For example, even in the absence of the training loss curve 402 and thus of the perturbation neighborhood, the perturbation component 114 can nevertheless perturb internal parameter values of each of the set of network copies 302, by randomly/stochastically adjusting such internal parameter values within any suitable percentage band. As a non-limiting example, the perturbation component 114 can select any suitable positive real-number g, and, for each internal parameter of a given network copy in the set of network copies 302, the perturbation component 114 can randomly change such internal parameter by ±g % or less. Thus, even in the absence of the training loss curve 402, the perturbation component 114 can, in various cases, nevertheless generate the set of perturbed network instantiations 202.

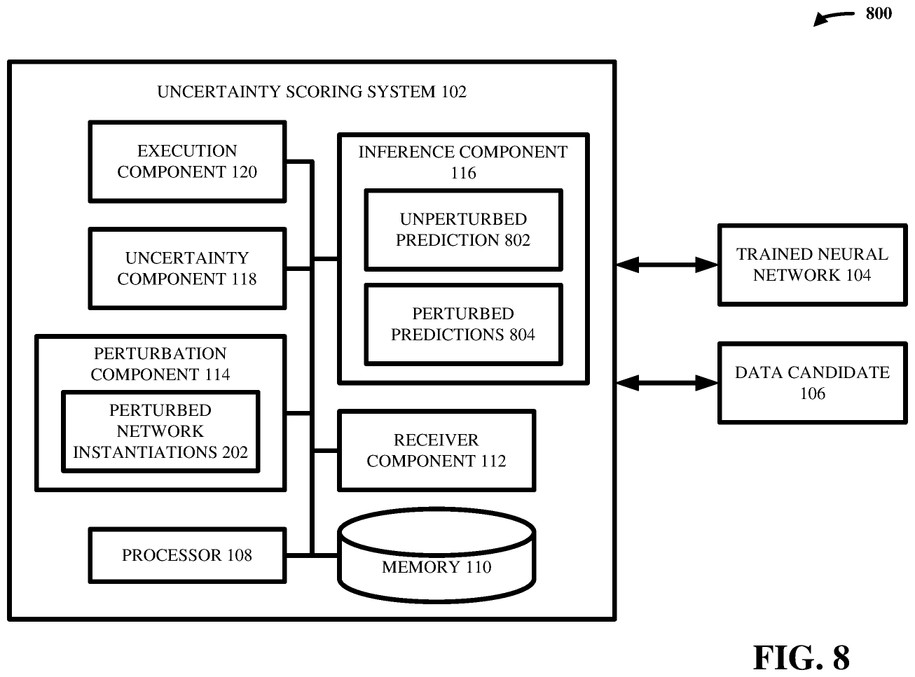

FIG. 8 illustrates a block diagram of an example, non-limiting system 800 including an unperturbed prediction and/or a set of perturbed predictions that can facilitate improved uncertainty scoring for neural networks via stochastic weight perturbations in accordance with one or more embodiments described herein. As shown, the system 800 can, in some cases, comprise the same components as the system 200, and can further comprise an unperturbed prediction 802 and/or a set of perturbed predictions 804.

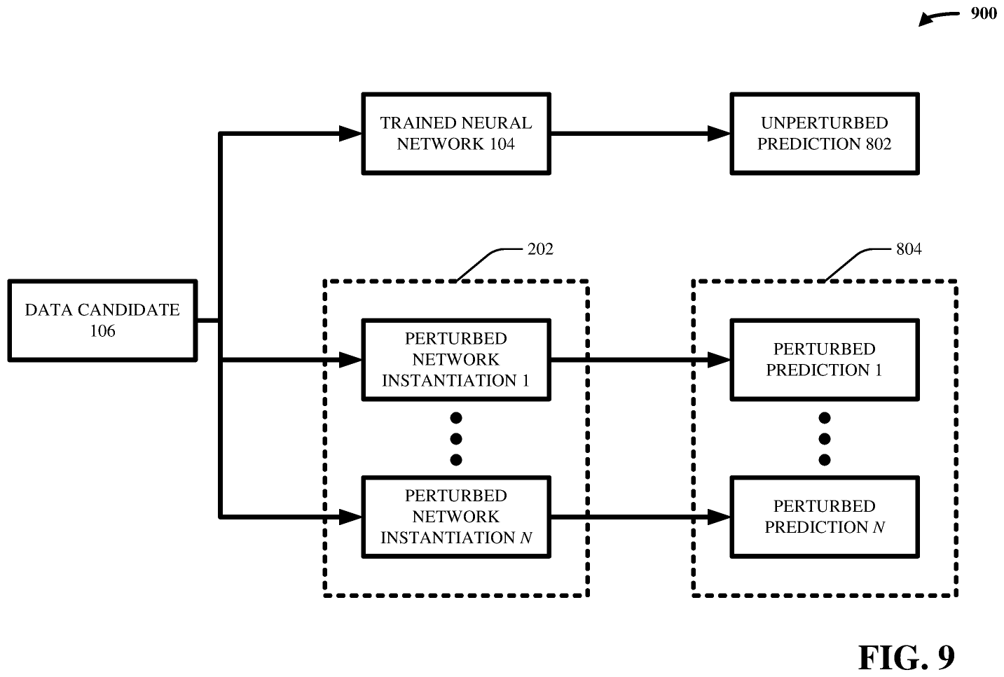

In various embodiments, the inference component 116 can electronically generate the unperturbed prediction 802 and/or the set of perturbed predictions 804 based on the trained neural network 104, based on the set of perturbed network instantiations 202, and/or based on the data candidate 106. More specifically, the inference component 116 can generate the unperturbed prediction 802 by executing the trained neural network 104 on the data candidate 106, and/or the inference component 116 can generate the set of perturbed predictions 804 by respectively executing the set of perturbed network instantiations 202 on the data candidate 106. This is further described with respect to FIG. 9.

FIG. 9 illustrates an example, non-limiting block diagram 900 showing how the unperturbed prediction 802 and/or the set of perturbed predictions 804 can be generated in accordance with one or more embodiments described herein.

As shown, in various aspects, the inference component 116 can execute the trained neural network 104 on the data candidate 106, which can cause the trained neural network 104 to produce the unperturbed prediction 802. In particular, the inference component 116 can feed the data candidate 106 to an input layer of the trained neural network 104, the data candidate 106 can complete a forward pass through one or more hidden layers of the trained neural network 104, and/or an output layer of the trained neural network 104 can compute the unperturbed prediction 802 based on activations provided by the one or more hidden layers of the trained neural network 104. As those having ordinary skill in the art will appreciate, and as mentioned above, the unperturbed prediction 802 can exhibit any suitable format and/or dimensionality as desired (e.g., can be one or more scalars, one or more vectors, one or more matrices, one or more tensors, and/or one or more character strings). As a non-limiting example, the unperturbed prediction 802 can be a classification label that the trained neural network 104 has generated for the data candidate 106. As another non-limiting example, the unperturbed prediction 802 can be a segmentation mask that the trained neural network 104 has generated for the data candidate 106. As yet another non-limiting example, the unperturbed prediction 802 can be a denoised, enhanced, and/or otherwise transformed version of the data candidate 106 that the trained neural network 104 has generated. In any case, the unperturbed prediction 802 can be referred to as “unperturbed” since the internal parameter values of the trained neural network 104 can be the unperturbed, optimized values that were achieved during/via training.

As also shown, in various aspects, the inference component 116 can respectively execute the set of perturbed network instantiations 202 on the data candidate 106, which can cause the set of perturbed network instantiations 202 to respectively produce the set of perturbed predictions 804. Indeed, as shown, the set of perturbed predictions 804 can respectively correspond (e.g., in one-to-one fashion) to the set of perturbed network instantiations 202. That is, since the set of perturbed network instantiations 202 can include n instantiations, the set of perturbed predictions 804 can likewise include n predictions: a perturbed prediction 1 to a perturbed prediction n.

As a non-limiting example, the perturbed prediction 1 can correspond to the perturbed network instantiation 1. In other words, the inference component 116 can execute the perturbed network instantiation 1 on the data candidate 106, which can cause the perturbed network instantiation 1 to produce the perturbed prediction 1. More specifically, the inference component 116 can feed the data candidate 106 to an input layer of the perturbed network instantiation 1, the data candidate 106 can complete a forward pass through one or more hidden layers of the perturbed network instantiation 1, and/or an output layer of the perturbed network instantiation 1 can compute the perturbed prediction 1 based on activations provided by the one or more hidden layers of the perturbed network instantiation 1. As those having ordinary skill in the art will appreciate, the perturbed prediction 1 can exhibit the same format and/or dimensionality as the unperturbed prediction 802. For instance, if the unperturbed prediction 802 is a classification label that the trained neural network 104 has generated based on the data candidate 106, then the perturbed prediction 1 can likewise be a classification label that the perturbed network instantiation 1 has generated for the data candidate 106. As another instance, if the unperturbed prediction 802 is a segmentation mask that the trained neural network 104 has generated based on the data candidate 106, then the perturbed prediction 1 can likewise be a segmentation mask that the perturbed network instantiation 1 has generated for the data candidate 106. As yet another instance, if the unperturbed prediction 802 is a transformed version of the data candidate 106 that the trained neural network 104 has generated, then the perturbed prediction 1 can likewise be a transformed version of the data candidate 106 that the perturbed network instantiation 1 has generated. In any case, the perturbed prediction 1 can be referred to as “perturbed” since the internal parameter values of the perturbed network instantiation 1 can have been perturbed from the optimized values that were achieved during/via training.

As another non-limiting example, the perturbed prediction n can correspond to the perturbed network instantiation n. That is, the inference component 116 can execute the perturbed network instantiation n on the data candidate 106, which can cause the perturbed network instantiation n to produce the perturbed prediction n. In particular, and just as above, the inference component 116 can feed the data candidate 106 to an input layer of the perturbed network instantiation n, the data candidate 106 can complete a forward pass through one or more hidden layers of the perturbed network instantiation n, and/or an output layer of the perturbed network instantiation n can compute the perturbed prediction n based on activations provided by the one or more hidden layers of the perturbed network instantiation n. As those having ordinary skill in the art will appreciate, the perturbed prediction n can exhibit the same format and/or dimensionality as the unperturbed prediction 802. For instance, if the unperturbed prediction 802 is a classification label that the trained neural network 104 has generated based on the data candidate 106, then the perturbed prediction n can likewise be a classification label that the perturbed network instantiation n has generated for the data candidate 106. As another instance, if the unperturbed prediction 802 is a segmentation mask that the trained neural network 104 has generated based on the data candidate 106, then the perturbed prediction n can likewise be a segmentation mask that the perturbed network instantiation n has generated for the data candidate 106. As yet another instance, if the unperturbed prediction 802 is a transformed version of the data candidate 106 that the trained neural network 104 has generated, then the perturbed prediction n can likewise be a transformed version of the data candidate 106 that the perturbed network instantiation n has generated. In any case, the perturbed prediction n can be referred to as “perturbed” since the internal parameter values of the perturbed network instantiation n can have been perturbed from the optimized values that were achieved during/via training.

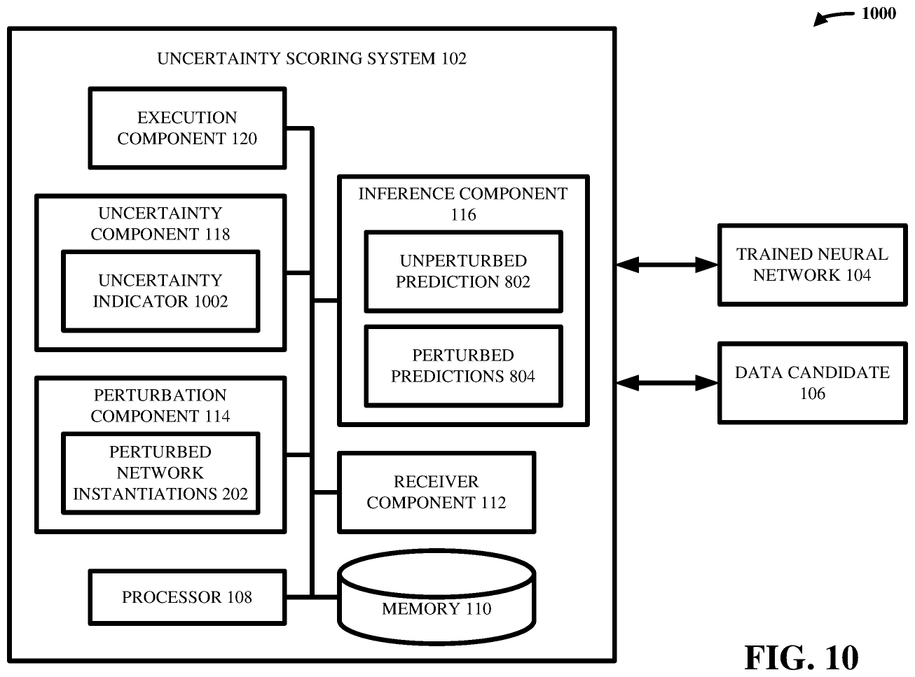

FIG. 10 illustrates a block diagram of an example, non-limiting system 1000 including an uncertainty indicator that can facilitate improved uncertainty scoring for neural networks via stochastic weight perturbations in accordance with one or more embodiments described herein. As shown, the system 1000 can, in some cases, comprise the same components as the system 800, and can further comprise an uncertainty indicator 1002.

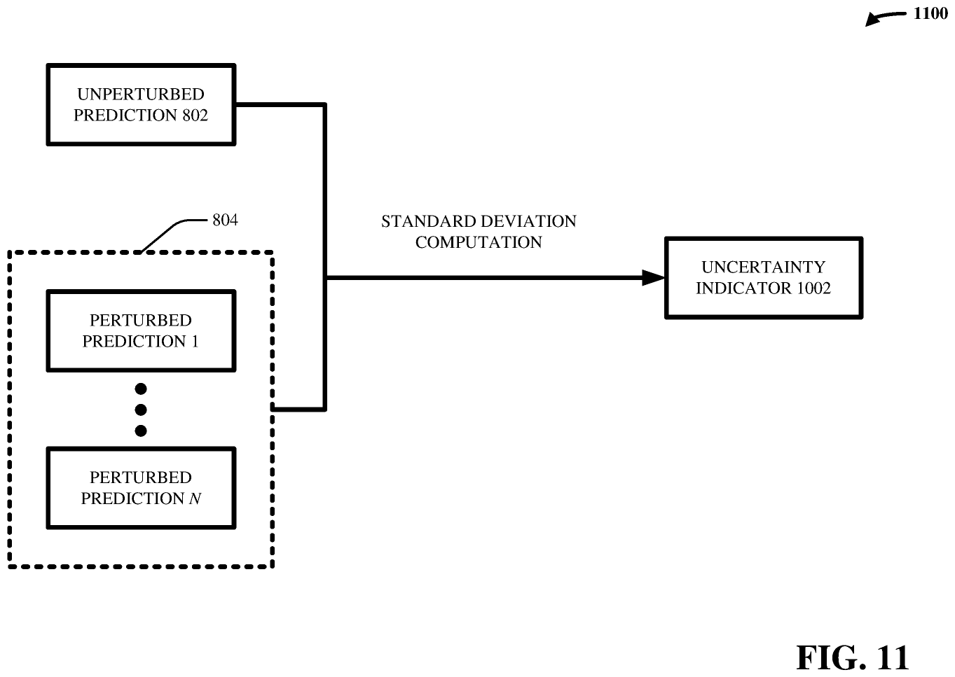

In various embodiments, the uncertainty component 118 can electronically generate the uncertainty indicator 1002 based on the unperturbed prediction 802 and/or based on the set of perturbed predictions 804. This is described in more detail with respect to FIG. 11.

FIG. 11 illustrates an example, non-limiting block diagram 1100 showing how the uncertainty indicator 1002 can be generated in accordance with one or more embodiments described herein.

In various embodiments, as shown, the uncertainty component 118 can electronically generate the uncertainty indicator 1002 by applying a standard deviation computation to the unperturbed prediction 802 and/or to the set of perturbed predictions 804. More specifically, as mentioned above, the unperturbed prediction 802 and the set of perturbed predictions 804 can all have the same format/dimensionality as each other (e.g., the unperturbed prediction 802 and the set of perturbed predictions 804 can all be classification labels of the data candidate 106, can all be segmentation masks of the data candidate 106, and/or can all be transformed versions of the data candidate 106). Accordingly, in various instances, the uncertainty component 118 can compute element-wise standard deviations across all of the unperturbed prediction 802 and the set of perturbed predictions 804. In various cases, such element-wise standard deviations can be considered as the uncertainty indicator 1002.

As a non-limiting example, suppose that the unperturbed prediction 802 is a b-by-c matrix, for any suitable positive integers b and c. Thus, it can be the case that each of the set of perturbed predictions 804 is also a b-by-c matrix. In various aspects, when the unperturbed prediction 802 and the set of perturbed predictions 804 are all taken together/collectively, they can be considered as forming a total set of b-by-c matrices (e.g., a total set of predictions), which total set has a cardinality of n+1. In various instances, the uncertainty component 118 can compute, in element-wise fashion, the standard deviation of such total set of predictions, and such standard deviation can be considered as the uncertainty indicator 1002. More specifically, since each of the unperturbed prediction 802 and the set of perturbed predictions 804 can be a b-by-c matrix, the uncertainty indicator 1002 can likewise be a b-by-c matrix. Moreover, for any suitable positive integers i and j such that 1≤i≤b and 1≤j≤c, an element (i,j) in the uncertainty indicator 1002 can be equal to and/or otherwise based on the standard deviation of the n+1 unique elements (i,j) that are collectively in the total set of predictions (e.g., that are collectively in the unperturbed prediction 802 and the set of perturbed predictions 804). In other words, the element (i,j) of the uncertainty indicator 1002 can be considered as quantifying how widely the elements (i,j) in the total set of predictions vary from each other. In still other words, the total set of predictions (e.g., the unperturbed prediction 802 and the set of perturbed predictions 804) can have a total of n+1 unique elements that are located at position (i,j), and the element (i,j) of the uncertainty indicator 1002 can be equal to the standard deviation of such n+1 unique elements that are located at position (i,j) (e.g., can quantify how widely such n+1 unique elements that are located at position (i,j) vary from each other).

Although the above example specifically pertains to predictions that are in the form of two-dimensional matrices, this is a mere non-limiting example for ease of explanation. Those having ordinary skill in the art will appreciate that, no matter the format/dimensionality of the unperturbed prediction 802 and the set of perturbed predictions 804, the uncertainty indicator 1002 can be equal to and/or otherwise based on the standard deviation of the unperturbed prediction 802 and the set of perturbed predictions 804.

Furthermore, although the herein disclosure mainly describes various embodiments of the uncertainty indicator 1002 as being based on a standard deviation computation, this is a mere non-limiting example for ease of explanation. In various aspects, those having ordinary skill in the art will appreciate that the uncertainty indicator 1002 can be based on any other suitable measure of spread/variation (e.g., can be equal to and/or otherwise based on element-wise variance of the unperturbed prediction 802 and the set of perturbed predictions 804).

In any case, the uncertainty component 118 can compute/calculate the uncertainty indicator 1002 based on the unperturbed prediction 802 and/or based on the set of perturbed predictions 804, where the uncertainty indicator 1002 can be considered as quantifying how similar and/or how different the unperturbed prediction 802 and/or the set of perturbed predictions 804 all are from each other. In various aspects, the more similar (e.g., in an element-wise sense) that the unperturbed prediction 802 and the set of perturbed predictions 804 all are to each other, the lower/smaller the magnitudes of the uncertainty indicator 1002 can be. In contrast, the less similar (e.g., in an element-wise sense) that the unperturbed prediction 802 and the set of perturbed predictions 804 all are to each other, the larger/higher the magnitudes of the uncertainty indicator 1002 can be.

Note that, when the uncertainty indicator 1002 has larger/higher values, this can indicate that small changes (e.g., perturbations) in the internal parameters of the trained neural network 104 caused disproportionately large changes in the outputted predictions corresponding to the data candidate 106 (e.g., caused disproportionately large changes in the unperturbed prediction 802 and the set of perturbed predictions 804). In such case, it can be concluded that the trained neural network 104 exhibits less confidence and/or more uncertainty when analyzing the data candidate 106. On the other hand, when the uncertainty indicator 1002 has lower/smaller values, this can indicate that small changes (e.g., perturbations) in the internal parameters of the trained neural network 104 caused commensurately small changes in the outputted predictions corresponding to the data candidate 106 (e.g., caused commensurately small changes in the unperturbed prediction 802 and the set of perturbed predictions 804). In such case, it can instead be concluded that the trained neural network 104 exhibits more confidence and/or less uncertainty when analyzing the data candidate 106. Accordingly, because the uncertainty indicator 1002 can indicate how the predicted outputs of the trained neural network 104 changed in response to internal parameter perturbations, the uncertainty indicator 1002 can be considered as quantifying with how much confidence and/or with how much uncertainty the trained neural network 104 can be executed on the data candidate 106. Therefore, the uncertainty indicator 1002 can be considered as an uncertainty score and/or as a confidence score for the trained neural network 104 and/or the data candidate 106.

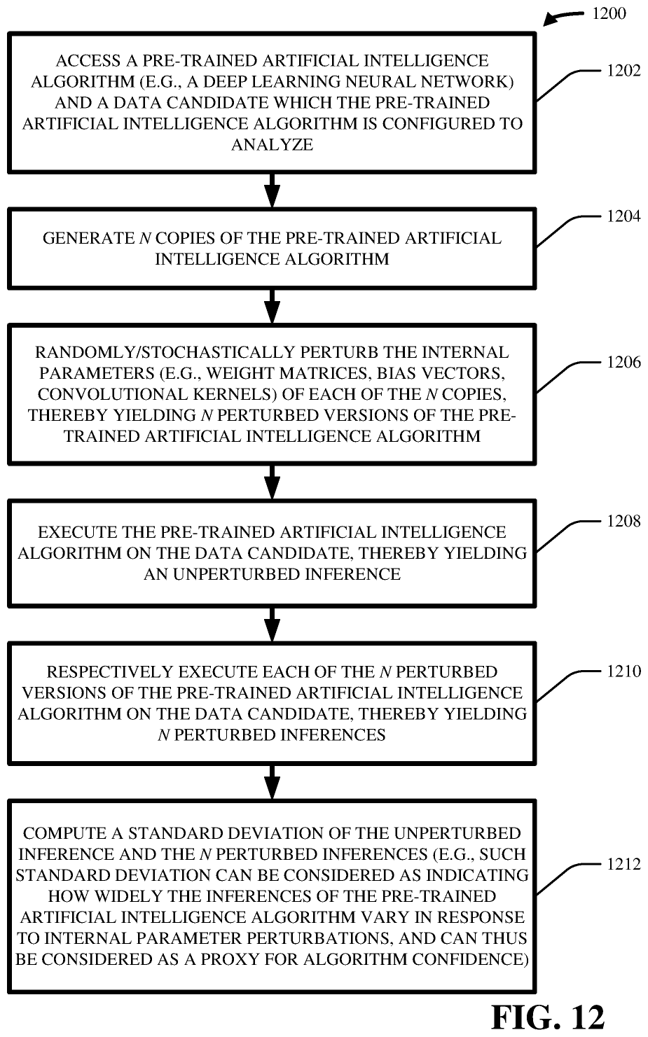

FIG. 12 illustrates a flow diagram of an example, non-limiting computer-implemented method 1200 that can facilitate improved uncertainty scoring for neural networks via stochastic weight perturbations in accordance with one or more embodiments described herein. In various cases, the uncertainty scoring system 102 can facilitate the computer-implemented method 1200.

In various embodiments, act 1202 can include accessing, by a device (e.g., via 112) operatively coupled to a processor, a pre-trained artificial intelligence algorithm (e.g., 104) and a data candidate (e.g., 106) which the pre-trained artificial intelligence algorithm is configured to analyze. In some cases, the pre-trained artificial intelligence algorithm can be a deep learning neural network.

In various aspects, act 1204 can include generating, by the device (e.g., via 114) n copies (e.g., 302) of the pre-trained artificial intelligence algorithm, for any suitable positive integer n.

In various instances, act 1206 can include randomly/stochastically perturbing, by the device (e.g., via 114), the internal parameters (e.g., weight matrices, bias vectors, convolutional kernels) of each of the n copies. This can yield n perturbed versions (e.g., 202) of the pre-trained artificial intelligence algorithm.

In various cases, act 1208 can include executing, by the device (e.g., via 116), the pre-trained artificial intelligence algorithm on the data candidate, thereby yielding an unperturbed inference (e.g., 802).

In various aspects, act 1210 can include respectively executing, by the device (e.g., via 116), the n perturbed versions of the pre-trained artificial intelligence algorithm on the data candidate, thereby yielding n perturbed inferences (e.g., 804).

In various instances, act 1212 can include computing, by the device (e.g., via 118), a standard deviation (e.g., 1002) of the unperturbed inference and the n perturbed inferences. In various cases, such standard deviation can be considered as indicating how widely the inferences outputted by the pre-trained artificial intelligence algorithm vary in response to internal parameter perturbations. Accordingly, such standard deviation can be considered as a proxy for algorithm confidence/uncertainty.

In various embodiments, the execution component 120 can electronically initiate any suitable electronic actions based on the uncertainty indicator 1002. As a non-limiting example, the execution component 120 can, in some cases, electronically render the uncertainty indicator 1002 on any suitable computer display/monitor/screen (not shown). Accordingly, a user/operator can visually inspect the uncertainty indicator 1002 to gain an understanding of the confidence/uncertainty of the trained neural network 104 with respect to the data candidate 106.

As another non-limiting example, the execution component 120 can electronically compare the uncertainty indicator 1002 to any suitable threshold values (not shown) as desired. In some cases, in response to the execution component 120 concluding that the uncertainty indicator 1002 does not satisfy the one or more threshold values, the execution component 120 can electronically transmit, to any suitable computing device, an electronic message stating that the trained neural network 104 is not capable of being confidently executed on the data candidate 106 (e.g., stating that the trained neural network 104 exhibits excessive uncertainty with respect to the data candidate 106). Accordingly, a user/operator that reads such electronic message can determine that some other neural network should be executed on the data candidate 106, instead of the trained neural network 104.

As yet another non-limiting example, the execution component 120 can electronically compare the uncertainty indicator 1002 to any suitable threshold values (not shown) as desired. In various aspects, in response to the execution component 120 concluding that the uncertainty indicator 1002 does not satisfy the one or more threshold values, the execution component 120 can electronically transmit, to any suitable computing device, an electronic message stating that the trained neural network 104 is not capable of being confidently executed on the data candidate 106 and further stating that manual review of the data candidate 106 by a subject matter expert is therefore warranted. Accordingly, a user/operator that reads such electronic message can determine whether or not to schedule/order a manual review of the data candidate 106.

As even another non-limiting example, the execution component 120 can electronically compare the uncertainty indicator 1002 to any suitable threshold values (not shown) as desired. In various aspects, in response to the execution component 120 concluding that the uncertainty indicator 1002 does not satisfy the one or more threshold values, the execution component 120 can electronically transmit, to any suitable computing device, an electronic message stating that the trained neural network 104 is not capable of being confidently executed on the data candidate 106 and further stating that re-acquisition of the data candidate 106 using different acquisition protocols/parameters is therefore warranted. Accordingly, a user/operator that reads such electronic message can determine whether or not to schedule/order a re-acquisition of the data candidate 106. In some cases, the execution component 120 can electronically instruct/command an imaging device (e.g., CT scanner, Mill scanner, X-ray scanner) that captured/generated the data candidate 106 to re-capture/re-generate the data candidate 106 according to different parameters/settings (e.g., different voltage level, different reconstruction technique).

These functionalities of the execution component 120 are mere non-limiting examples for ease of explanation. Those having ordinary skill in the art will appreciate that the execution component 120 can leverage the uncertainty indicator 1002 for any suitable tasks as desired (e.g., uncertainty scores computed as described herein can be used to choose which neural network from a zoo/vault of neural networks should be deployed for a given data candidate; uncertainty scores computed as described herein can be used in place of and/or in addition to accuracy to guide neural network compression).

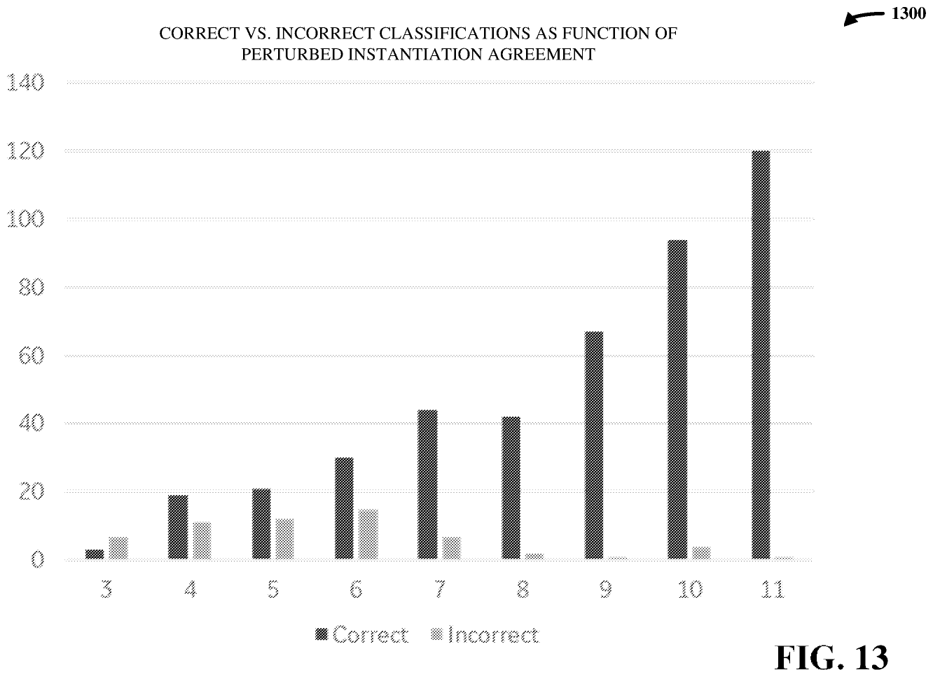

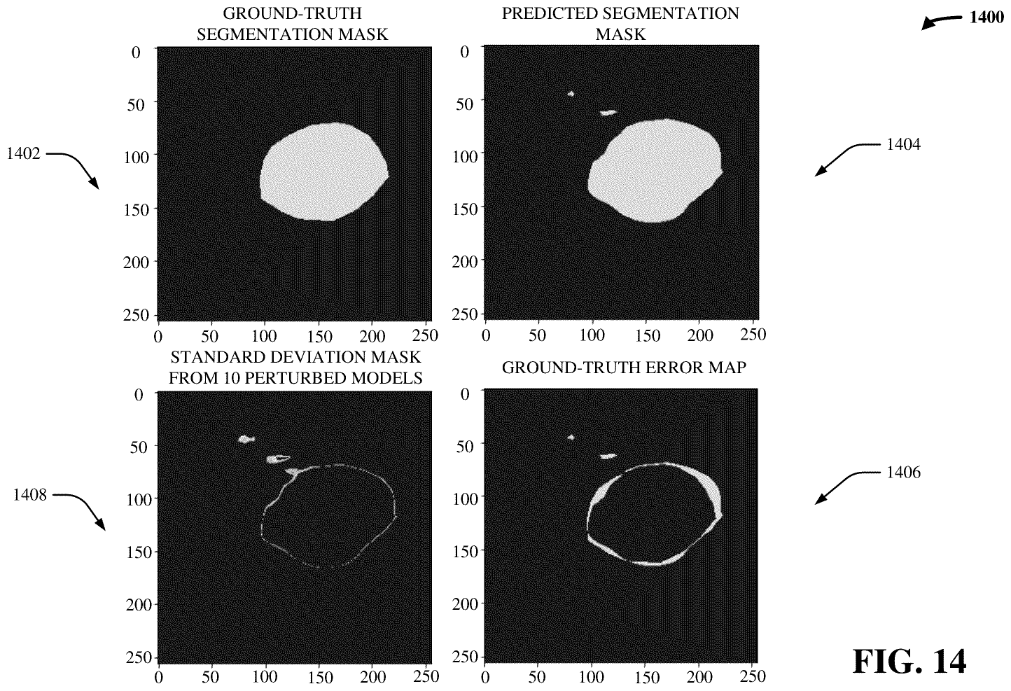

To demonstrate the benefits of various embodiments described herein, the present inventors performed various experiments. Some results of such experiments are shown with respect to FIGS. 13-14.

FIGS. 13-14 illustrate example, non-limiting experimental results that demonstrate the efficacy of uncertainty scoring via perturbed instantiations of neural networks in accordance with one or more embodiments described herein.

First, consider FIG. 13. As shown, FIG. 13 depicts a bar graph 1300. In various aspects, the present inventors obtained a trained neural network classifier that was configured to receive as input a CT scanned image of a patient's heart and to produce as output a classification label that identifies which of eight unique cardiac views was visually illustrated in the CT scanned image. The present inventors then created, as described herein, ten unique perturbed instantiations of the trained neural network classifier, thereby yielding a total of eleven classifiers. In various aspects, the present inventors respectively executed each of such eleven classifiers on a validation dataset for which ground-truth classifications were known. In various instances, the results of such executions are shown in the bar graph 1300. More specifically, the abscissa (e.g., x-axis) of the bar graph 1300 can represent the maximum number of the eleven classifiers that agreed with each other (e.g., that generated the same classification label) for any given inputted CT scanned image, and the ordinate (e.g., y-axis) of the bar graph 1300 can represent how many inputted CT scanned images were correctly and/or incorrectly analyzed by that maximum number in agreement. As shown in the bar graph 1300, when very few of the eleven classifiers agreed with each other (e.g., when only three classifiers were in agreement, when only four classifiers were agreement, when only five classifiers were in agreement), those classifiers that agreed with each other were significantly likely to be incorrect. In stark contrast, and as also shown in the bar graph 1300, when very many of the eleven classifiers agreed with each other (e.g., when nine classifiers were in agreement, when ten classifiers were in agreement, when eleven classifiers were in agreement), those classifiers that agreed with each other were much, much more likely to be correct. In other words, as variation (e.g., standard deviation) among the outputted classification labels produced by the eleven perturbed classifiers increased, the likelihood of the outputted classification labels being incorrect significantly increased. Conversely, as variation (e.g., standard deviation) among the outputted classification labels produced by the eleven perturbed classifiers decreased, the likelihood of the outputted classification labels being incorrect significantly decreased. Accordingly, the bar graph 1300 helps to show that the herein-described technique for facilitating uncertainty scoring (e.g., standard deviation of outputs produced by perturbed neural networks) closely tracks likelihood of correctness/incorrectness, and thus can be a good proxy for confidence/uncertainty.

Next, consider FIG. 14. As shown, FIG. 14 depicts a view 1400 of various data pertaining to image segmentation. In particular, the present inventors obtained a trained segmentation network that was configured to receive as input an ultrasound scanned image of a fetus within a patient and to produce as output a segmentation mask that identifies which pixels of the ultrasound scanned image depict the fetus and which pixels otherwise depict background anatomical structures. In various aspects, the present inventors executed the trained segmentation network on a given ultrasound scanned image for which a ground-truth segmentation mask was known. In various instances, the ground-truth segmentation mask is shown by numeral 1402 in FIG. 14, and the predicted output produced by the trained segmentation network is shown by numeral 1404 in FIG. 14. In various cases, the present inventors computed an error map by subtracting the ground-truth segmentation mask (e.g., 1402) from the predicted segmentation mask (e.g., 1404) outputted by the trained segmentation network. In various aspects, such error map is shown by numeral 1406 in FIG. 14. In various cases, pixels that have high values (e.g., light/bright colors) in the error map (e.g., in 1406) can be considered as having been incorrectly analyzed by the trained segmentation network, whereas pixels that instead have low values (e.g., dark colors) in the error map (e.g., in 1406) can be considered as having been correctly analyzed by the trained segmentation network. Next, the present inventors created, as described herein, nine unique perturbed instantiations of the trained segmentation network and respectively executed each of such nine instantiations on the given ultrasound scanned image, thereby yielding nine perturbed predicted segmentation masks. Note that the predicted segmentation mask produced by the trained segmentation network and the nine predicted segmentation masks respectively produced by the nine perturbed instantiations can be considered as forming a set of ten predicted segmentation masks in total. In various aspects, the present inventors computed an element-wise standard deviation of such ten predicted segmentation masks. Such element-wise standard deviation is shown by numeral 1408 in FIG. 14. In various instances, pixels that have high values (e.g., light/bright colors) in the element-wise standard deviation (e.g., in 1408) can be considered as varying widely across the ten predicted segmentation masks, whereas pixels that instead have low values (e.g., dark colors) in the element-wise standard deviation (e.g., in 1408) can be considered as varying narrowly or not at all across the ten predicted segmentation masks. As can be visually seen, the element-wise standard deviation (e.g., 1408) closely tracks the error map (e.g., 1406), notwithstanding that the element-wise standard deviation (e.g., 1408) was computed without making any reference to the ground-truth segmentation mask (e.g., 1402). Accordingly, FIG. 14 shows that standard deviation of perturbed predictions can act as a good proxy for neural network confidence/uncertainty.

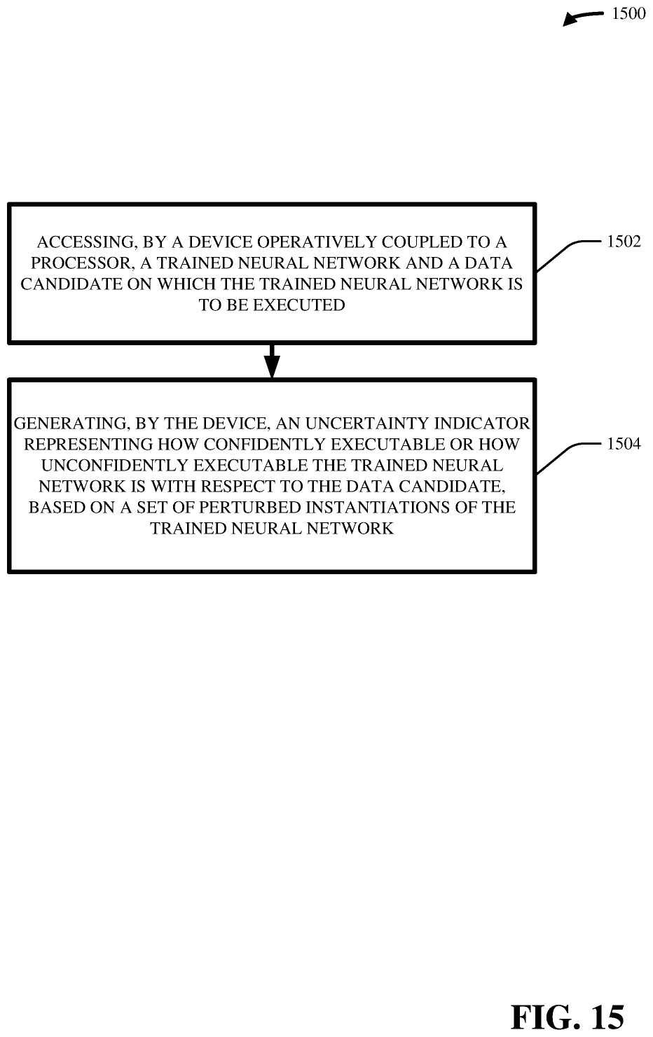

FIG. 15 illustrates a flow diagram of an example, non-limiting computer-implemented method 1500 that can facilitate improved uncertainty scoring for neural networks via stochastic weight perturbations in accordance with one or more embodiments described herein. In various cases, the uncertainty scoring system 102 can facilitate the computer-implemented method 1500.

In various embodiments, act 1502 can include accessing, by a device (e.g., via 112) operatively coupled to a processor, a trained neural network (e.g., 104) and/or a data candidate (e.g., 106) on which the trained neural network is to be executed.

In various aspects, act 1504 can include generating, by the device (e.g., via 118), an uncertainty indicator (e.g., 1002) representing how confidently executable or how unconfidently executable the trained neural network is with respect to the data candidate, based on a set of perturbed instantiations (e.g., 202) of the trained neural network.

Although not explicitly shown in FIG. 15, the computer-implemented method 1500 can further comprise: generating, by the device (e.g., via 114), the set of perturbed instantiations of the trained neural network, by randomly perturbing internal parameters of the trained neural network. In various cases, the randomly perturbing can include stochastically sampling the internal parameters within a loss neighborhood of the trained neural network, and wherein the loss neighborhood can be based on a slope of a parabola (e.g., 602) that has been fitted to a loss curve (e.g., 402) of the trained neural network (e.g., as explained with respect to FIGS. 4-7), or wherein the loss neighborhood can be based on a relative change in the loss curve compared to a local minimum of the loss curve. In various aspects, the parabola can be fitted to the loss curve along a direction given by a top eigenvector of a Hessian of the loss curve evaluated at the local minimum of the loss curve.

Although not explicitly shown in FIG. 15, the computer-implemented method 1500 can further comprise: generating, by the device (e.g., via 116), a set of perturbed predictions (e.g., 804), by respectively executing the set of perturbed instantiations of the trained neural network on the data candidate, wherein respective ones of the set of perturbed instantiations receive as input the data candidate and produce as output respective ones of the set of perturbed predictions (e.g., as shown with respect to FIG. 9). In various cases, the uncertainty indicator can be based on a standard deviation of the set of perturbed predictions.

Various embodiments described herein can be considered as a computerized tool for facilitating improved uncertainty scoring for neural networks via stochastic weight perturbations. As described herein, such computerized tool can facilitate uncertainty scoring of an already-trained neural network by computing a standard deviation of predictions outputted by a set of perturbed versions of the already-trained neural network. In various aspects, such computerized tool can facilitate uncertainty scoring regardless of the architecture of the already-trained neural network, regardless of the type of training applied to the already-trained neural network, regardless of the specific content of training data on which the already-trained neural network was trained, and/or without consuming excessive computational resources. Accordingly, such a computerized tool thus certainly constitutes a concrete and tangible technical improvement in the field of neural networks.

Although the herein disclosure mainly describes various embodiments as applying to neural networks, this is a mere non-limiting example. In various aspects, the herein-described teachings can be extrapolated to any suitable machine learning model regardless of architecture (e.g., to neural networks, to support vector machines, to naïve Bayes models, to decision trees, to linear regression models, and/or to logistic regression models).

In various instances, machine learning algorithms and/or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features and/or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

A classifier can map an input attribute vector, z=(z₁, z₂, z₃, z₄, zₙ), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

Those having ordinary skill in the art will appreciate that the herein disclosure describes non-limiting examples of various embodiments. For ease of description and/or explanation, various portions of the herein disclosure utilize the term “each” when discussing various embodiments. Those having ordinary skill in the art will appreciate that such usages of the term “each” are non-limiting examples. In other words, when the herein disclosure provides a description that is applied to “each” of some particular object and/or component, it should be understood that this is a non-limiting example of various embodiments, and it should be further understood that, in various other embodiments, it can be the case that such description applies to fewer than “each” of that particular object and/or component.

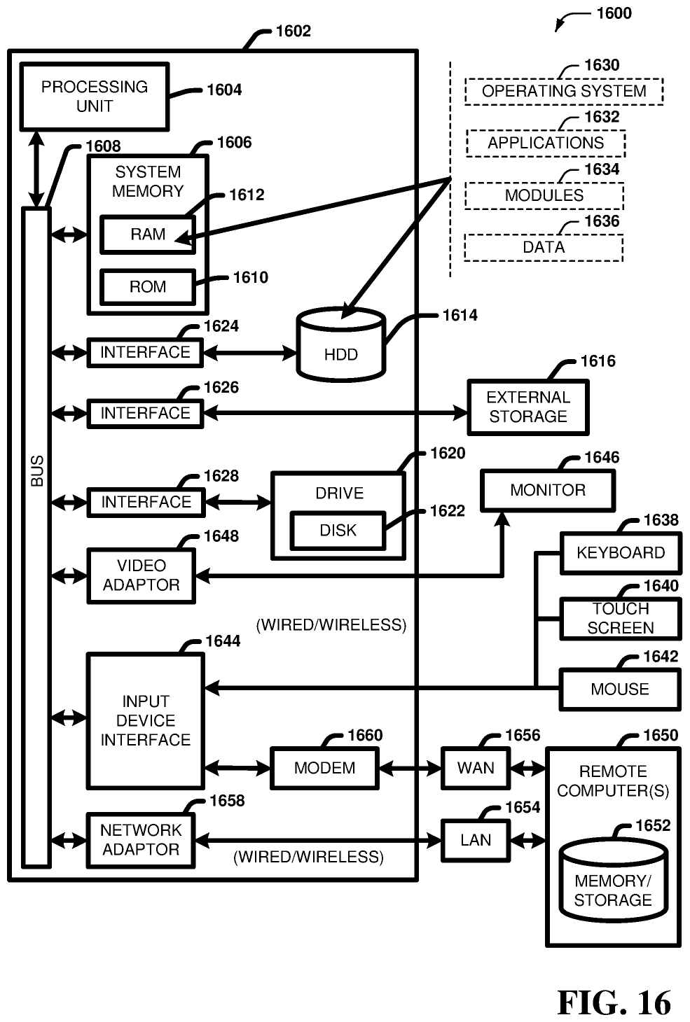

In order to provide additional context for various embodiments described herein, FIG. 16 and the following discussion are intended to provide a brief, general description of a suitable computing environment 1600 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 16, the example environment 1600 for implementing various embodiments of the aspects described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

The computer 1602 further includes an internal hard disk drive (HDD) 1614 (e.g., EIDE, SATA), one or more external storage devices 1616 (e.g., a magnetic floppy disk drive (FDD) 1616, a memory stick or flash drive reader, a memory card reader, etc.) and a drive 1620, e.g., such as a solid state drive, an optical disk drive, which can read or write from a disk 1622, such as a CD-ROM disc, a DVD, a BD, etc. Alternatively, where a solid state drive is involved, disk 1622 would not be included, unless separate. While the internal HDD 1614 is illustrated as located within the computer 1602, the internal HDD 1614 can also be configured for external use in a suitable chassis (not shown). Additionally, while not shown in environment 1600, a solid state drive (SSD) could be used in addition to, or in place of, an HDD 1614. The HDD 1614, external storage device(s) 1616 and drive 1620 can be connected to the system bus 1608 by an HDD interface 1624, an external storage interface 1626 and a drive interface 1628, respectively. The interface 1624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the .NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can be enable with a security module, such as a trusted processing module (TPM). For instance with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1394 serial port, a game port, a USB port, an IR interface, a BLUETOOTH® interface, etc.

A monitor 1646 or other type of display device can be also connected to the system bus 1608 via an interface, such as a video adapter 1648. In addition to the monitor 1646, a computer typically includes other peripheral output devices (not shown), such as speakers, printers, etc.

The computer 1602 can operate in a networked environment using logical connections via wired and/or wireless communications to one or more remote computers, such as a remote computer(s) 1650. The remote computer(s) 1650 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1652 is illustrated. The logical connections depicted include wired/wireless connectivity to a local area network (LAN) 1654 and/or larger networks, e.g., a wide area network (WAN) 1656. Such LAN and WAN networking environments are commonplace in offices and companies, and facilitate enterprise-wide computer networks, such as intranets, all of which can connect to a global communications network, e.g., the Internet.

When used in a LAN networking environment, the computer 1602 can be connected to the local network 1654 through a wired and/or wireless communication network interface or adapter 1658. The adapter 1658 can facilitate wired or wireless communication to the LAN 1654, which can also include a wireless access point (AP) disposed thereon for communicating with the adapter 1658 in a wireless mode.

When used in a WAN networking environment, the computer 1602 can include a modem 1660 or can be connected to a communications server on the WAN 1656 via other means for establishing communications over the WAN 1656, such as by way of the Internet. The modem 1660, which can be internal or external and a wired or wireless device, can be connected to the system bus 1608 via the input device interface 1644. In a networked environment, program modules depicted relative to the computer 1602 or portions thereof, can be stored in the remote memory/storage device 1652. It will be appreciated that the network connections shown are example and other means of establishing a communications link between the computers can be used.

When used in either a LAN or WAN networking environment, the computer 1602 can access cloud storage systems or other network-based storage systems in addition to, or in place of, external storage devices 1616 as described above, such as but not limited to a network virtual machine providing one or more aspects of storage or processing of information. Generally, a connection between the computer 1602 and a cloud storage system can be established over a LAN 1654 or WAN 1656 e.g., by the adapter 1658 or modem 1660, respectively. Upon connecting the computer 1602 to an associated cloud storage system, the external storage interface 1626 can, with the aid of the adapter 1658 and/or modem 1660, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

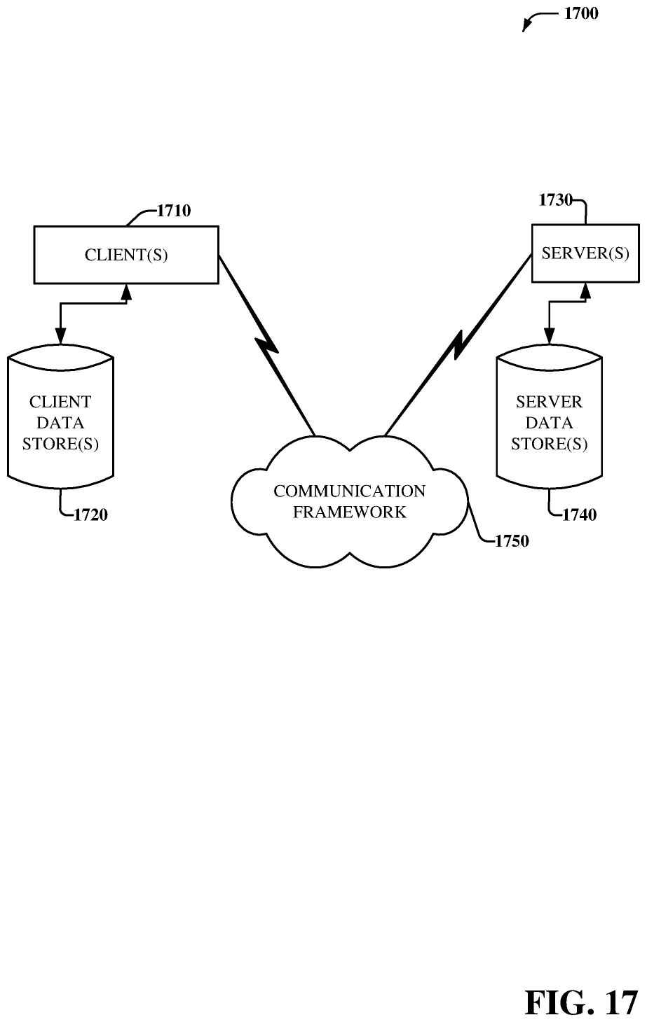

FIG. 17 is a schematic block diagram of a sample computing environment 1700 with which the disclosed subject matter can interact. The sample computing environment 1700 includes one or more client(s) 1710. The client(s) 1710 can be hardware and/or software (e.g., threads, processes, computing devices). The sample computing environment 1700 also includes one or more server(s) 1730. The server(s) 1730 can also be hardware and/or software (e.g., threads, processes, computing devices). The servers 1730 can house threads to perform transformations by employing one or more embodiments as described herein, for example. One possible communication between a client 1710 and a server 1730 can be in the form of a data packet adapted to be transmitted between two or more computer processes. The sample computing environment 1700 includes a communication framework 1750 that can be employed to facilitate communications between the client(s) 1710 and the server(s) 1730. The client(s) 1710 are operably connected to one or more client data store(s) 1720 that can be employed to store information local to the client(s) 1710. Similarly, the server(s) 1730 are operably connected to one or more server data store(s) 1740 that can be employed to store information local to the servers 1730.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor that executes computer-executable components stored in a computer-readable memory, the computer-executable components comprising:
a receiver component that accesses a trained neural network and a data candidate on which the trained neural network is to be executed; and
an uncertainty component that generates an uncertainty indicator representing how confidently executable or how unconfidently executable the trained neural network is with respect to the data candidate, based on a set of perturbed instantiations of the trained neural network.

2. The system of claim 1, wherein the computer-executable components further comprise:
a perturbation component that generates the set of perturbed instantiations of the trained neural network, by randomly perturbing internal parameters of the trained neural network.

3. The system of claim 2, wherein the randomly perturbing includes stochastically sampling the internal parameters within a loss neighborhood of the trained neural network, and wherein the loss neighborhood is based on a slope of a parabola that has been fitted to a loss curve of the trained neural network or is based on a relative change in the loss curve compared to a local minimum of the loss curve.

4. The system of claim 3, wherein the parabola is fitted to the loss curve along a direction given by a top eigenvector of a Hessian of the loss curve evaluated at the local minimum of the loss curve.

5. The system of claim 2, wherein the computer-executable components further comprise:
an inference component that generates a set of perturbed predictions, by respectively executing the set of perturbed instantiations of the trained neural network on the data candidate, wherein respective ones of the set of perturbed instantiations receive as input the data candidate and produce as output respective ones of the set of perturbed predictions.

6. The system of claim 5, wherein the uncertainty indicator is based on a standard deviation of the set of perturbed predictions.

7. The system of claim 1, wherein the computer-executable components further comprise:
an execution component that visually renders the uncertainty indicator on a computer display.

8. The system of claim 1, wherein the trained neural network is selected from a vault of trained neural networks, and wherein the computer-executable components further comprise:
an execution component that recommends, in response to a determination that the uncertainty indicator fails to satisfy a threshold, that the trained neural network is not confidently executable on the data candidate and that a different trained neural network from the vault of trained neural networks should be selected, or that recommends, in response to the determination that the uncertainty indicator fails to satisfy the threshold, that expert review of the data candidate is warranted.

9. A computer-implemented method, comprising:
accessing, by a device operatively coupled to a processor, a trained neural network and a data candidate on which the trained neural network is to be executed; and
generating, by the device, an uncertainty indicator representing how confidently executable or how unconfidently executable the trained neural network is with respect to the data candidate, based on a set of perturbed instantiations of the trained neural network.

10. The computer-implemented method of claim 9, further comprising:
generating, by the device, the set of perturbed instantiations of the trained neural network, by randomly perturbing internal parameters of the trained neural network.

11. The computer-implemented method of claim 10, wherein the randomly perturbing includes stochastically sampling the internal parameters within a loss neighborhood of the trained neural network, and wherein the loss neighborhood is based on a slope of a parabola that has been fitted to a loss curve of the trained neural network or is based on a relative change in the loss curve compared to a local minimum of the loss curve.

12. The computer-implemented method of claim 11, wherein the parabola is fitted to the loss curve along a direction given by a top eigenvector of a Hessian of the loss curve evaluated at the local minimum of the loss curve.

13. The computer-implemented method of claim 10, further comprising:
generating, by the device, a set of perturbed predictions, by respectively executing the set of perturbed instantiations of the trained neural network on the data candidate, wherein respective ones of the set of perturbed instantiations receive as input the data candidate and produce as output respective ones of the set of perturbed predictions.

14. The computer-implemented method of claim 13, wherein the uncertainty indicator is based on a standard deviation of the set of perturbed predictions.

15. The computer-implemented method of claim 9, further comprising:
visually rendering, by the device, the uncertainty indicator on a computer display.

16. The computer-implemented method of claim 9, wherein the trained neural network is selected from a vault of trained neural networks, and further comprising:
recommending, by the device and in response to a determination that the uncertainty indicator fails to satisfy a threshold, that the trained neural network is not confidently executable on the data candidate and that a different trained neural network from the vault of trained neural networks should be selected, or that expert review of the data candidate is warranted.

17. A computer program product for facilitating improved uncertainty scoring for neural networks via stochastic weight perturbations, the computer program product comprising a computer-readable memory having program instructions embodied therewith, the program instructions executable by a processor to cause the processor to:
access a trained neural network and a data candidate on which the trained neural network is to be executed; and
generate an uncertainty indicator representing how confidently executable or how unconfidently executable the trained neural network is with respect to the data candidate, based on a set of perturbed instantiations of the trained neural network.

18. The computer program product of claim 17, wherein the program instructions are further executable to cause the processor to:
generate the set of perturbed instantiations of the trained neural network, by randomly perturbing internal parameters of the trained neural network.

19. The computer program product of claim 18, wherein the randomly perturbing includes stochastically sampling the internal parameters within a loss neighborhood of the trained neural network, and wherein the loss neighborhood is based on a slope of a parabola that has been fitted to a loss curve of the trained neural network or is based on a relative change in the loss curve compared to a local minimum of the loss curve.

20. The computer program product of claim 18, wherein the program instructions are further executable to cause the processor to:
generate a set of perturbed predictions, by respectively executing the set of perturbed instantiations of the trained neural network on the data candidate, wherein respective ones of the set of perturbed instantiations receive as input the data candidate and produce as output respective ones of the set of perturbed predictions, and wherein the uncertainty indicator is based on a standard deviation of the set of perturbed predictions.
